(19) United States
(12) Patent Application Publication
(10) Pub. No.: US 2026/0262051 A1
(43) Pub. Date: Sep. 3, 2026

(54) ENHANCED DOWNLINK DATA STEERING

(71) Applicant: RAKUTEN SYMPHONY, INC., Tokyo (JP)

(72) Inventors: Senthilnathan NATARAJAN, Bangalore (IN); Gopi RAVINDRAN, Bangalore (IN); Vijayakumar YALAMALLI, Bangalore (IN)

(73) Assignee: RAKUTEN SYMPHONY, INC., Tokyo (JP)

(21) Appl. No.: 19/066,306

(22) Filed: Feb. 28, 2025

(51) Int. Cl. H04W 72/231

(52) U.S. Cl. CPC H04W 72/231

(57) ABSTRACT

Example embodiments of the present disclosure relate to enhanced downlink data steering. According to example embodiments, a system may include a device that comprises a Radio Link Control (RLC) layer and a Media Access Control (MAC) layer. The device may be configured to implement the RLC layer to: provide, to a Control Component, information associated with the RLC layer and information associated with the MAC layer; receive, from the Control Component, a suggested amount of grant bytes based on the information associated with the RLC layer and the information associated with the MAC layer; provide, to the MAC layer, a request for a first amount of grant bytes based on the suggested grant bytes; receive, from the MAC layer, a second amount of grant bytes based on the first amount of grant bytes; and schedule transmission of a data packet based on the second amount of grant bytes.

### TECHNICAL FIELD

The present disclosure relates to enhanced downlink data steering.

### BACKGROUND

The information disclosed in this background section is only for the enhancement of understanding of the general background of the disclosure and should not be taken as an acknowledgement or any form of suggestion that this information forms the prior art already known to a person skilled in the art.

In a Radio Access Network (RAN) of a telecommunications network, a Distributed Unit (DU) may receive a data packet from a Central Unit (CU) and schedule the transmission of the data packet over the air interface. As a part of the scheduling process, the DU may perform downlink data steering to optimize the scheduling and transmission of the data packet based on various factors. For instance, the DU may determine the priority level of the data packet, prioritize high-priority traffic, adapt transmission parameters based on channel conditions, and the like.

### SUMMARY

Example embodiments of the present disclosure provide devices, systems, devices, methods, and the like, that effectively and efficiently enhance downlink data steering.

According to example embodiments, a system may include a device that comprises a Radio Link Control (RLC) layer and a Media Access Control (MAC) layer. The device may be configured to implement the RLC layer to: provide, to a Control Component, information associated with the RLC layer and information associated with the MAC layer; receive, from the Control Component, a suggested amount of grant bytes based on the information associated with the RLC layer and the information associated with the MAC layer; provide, to the MAC layer, a request for a first amount of grant bytes based on the suggested grant bytes; receive, from the MAC layer, a second amount of grant bytes based on the first amount of grant bytes; and schedule transmission of a data packet based on the second amount of grant bytes.

According to example embodiments, a method may include: providing, to a Control Component, information associated with a Radio Link Control (RLC) layer of a device and information associated with a Media Access Control (MAC) layer of the device; receiving, from the Control Component, a suggested amount of grant bytes based on the information associated with the RLC layer and the information associated with the MAC layer; providing, to the MAC layer, a request for a first amount of grant bytes based on the suggested grant bytes; receiving, from the MAC layer, a second amount of grant bytes based on the first amount of grant bytes; and scheduling transmission of a data packet based on the second amount of grant bytes.

According to example embodiments, a non-transitory computer-readable recording medium may have recorded thereon instructions executable by a device to cause the device to perform a method. The method may include: providing, to a Control Component, information associated with a Radio Link Control (RLC) layer of the device and information associated with a Media Access Control (MAC) layer of the device; receiving, from the Control Component, a suggested amount of grant bytes based on the information associated with the RLC layer and the information associated with the MAC layer; providing, to the MAC layer, a request for a first amount of grant bytes based on the suggested grant bytes; receiving, from the MAC layer, a second amount of grant bytes based on the first amount of grant bytes; and scheduling transmission of a data packet based on the second amount of grant bytes.

Additional aspects will be set forth in part in the description that follows and, in part, will be apparent from the description, or may be realized by practice of the presented embodiments of the disclosure.

### BRIEF DESCRIPTION OF THE DRAWINGS

Features, aspects, and advantages of embodiments of the disclosure will be described below with reference to the accompanying drawings, in which like reference numerals denote like elements, and wherein:

FIG. 1 illustrates a diagram of an example system, according to one or more example embodiments;

FIG. 2 illustrates a block diagram of an example method for scheduling transmission of a data packet, according to one or more example embodiments;

FIG. 3 illustrates a block diagram of an example method for providing a second amount of grant bytes, according to one or more example embodiments;

FIG. 4 illustrates a block diagram of an example method for providing a suggested amount of grant bytes, according to one or more example embodiments;

FIG. 5 illustrates a block diagram of an example method for reducing a data packet receiving rate, according to one or more example embodiments;

FIG. 6 illustrates a block diagram of an example method for providing a first amount of grant bytes, according to one or more example embodiments;

FIG. 7 illustrates a block diagram of an example method for scheduling transmission of a data packet, according to one or more example embodiments;

FIG. 8 illustrates a block diagram of an example method for managing communication between RLC layer and Control Component, according to one or more example embodiments;

FIGS. 9A and 9B illustrate a flow diagram of an example use case, according to one or more example embodiments;

FIG. 10 illustrates a block diagram of an O-RAN architecture, according to one or more example embodiments;

FIG. 11 illustrates a block diagram of an example device for implementing one or more example embodiments; and

FIG. 12 illustrates a block diagram of an example environment for implementing one or more example embodiments.

### DETAILED DESCRIPTION

The following detailed description of example embodiments refers to the accompanying drawings. The foregoing disclosure provides illustration and description, but is not intended to be exhaustive or to limit the implementations to the precise forms disclosed. Modifications and variations are possible in light of the above disclosure or may be acquired from practice of the implementations. Further, one or more features or components of one embodiment may be incorporated into or combined with another embodiment (or one or more features of another embodiment). Additionally, the flowchart and description of operations provided below relate to one of the various embodiments. It should be noted that it is possible to make other embodiments that do not exactly match the flowchart and its description. It is understood that in other embodiments one or more operations may be omitted, one or more operations may be added, one or more operations may be performed simultaneously (at least in part).

It will be apparent that systems and/or methods, described herein, may be implemented in different forms of hardware, firmware, or a combination of hardware and software. The actual specialized control hardware or software code used to implement these systems and/or methods is not limited to the described implementations. Thus, the operation and behavior of the systems and/or methods are described herein without reference to specific software code. It is understood that software and hardware may be designed to implement the systems and/or methods based on the description herein.

Even though particular combinations of features are disclosed in the claims and/or in the specification, these combinations are not intended to limit the disclosure of implementations. In fact, many of these features may be combined in ways not specifically recited in the claims and/or disclosed in the specification. Although each dependent claim listed below may directly depend on only one claim, the disclosure of implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]”, “[A] and/or [B]”, or “at least one of [A] or [B]”, are to be understood as including only A, only B, or both A and B.

Expressions such as “at least one processor,” where configured to implement a plurality of operations, execute a plurality of instructions, etc., are to be understood as a single processor implementing the plurality of operations, etc., or each of plural processors implementing at least some (but not necessarily all) of the plurality of operations, etc. In addition, expressions such as “a processor may be configured to perform an operation,” are to be understood as the processor may be configured to execute computer-executable instructions or programming codes to thereby perform an operation. Namely, the instructions or programming codes may be configured to cause the processor to perform an operation.

Reference throughout this specification to “one embodiment,” “embodiment,” “non-limiting exemplary embodiment,” “example embodiment,” or similar language means that a particular feature, structure, or characteristic described in connection with the indicated embodiment is included in at least one embodiment of the present solution. Thus, the phrases “in one embodiment”, “in an embodiment,” “in one non-limiting exemplary embodiment,” and similar language throughout this specification may, but do not necessarily, all refer to the same embodiment.

Further, the described features, advantages, and characteristics of the present disclosure may be combined in any suitable manner in one or more example embodiments. One skilled in the relevant art will recognize, in light of the description herein, that the present disclosure can be practiced without one or more of the specific features or advantages of a particular embodiment. In other instances, additional features and advantages may be recognized in certain embodiments that may not be present in all embodiments of the present disclosure.

In the present disclosure, specific tasks may be performed using Artificial Intelligence and/or Machine Leaning (AI/ML) models. An AI/ML model is a model generated using one or more AI technologies, one or more ML algorithm or both, and generates output data based on input data. This output data is used to perform tasks. Tasks performed using AI/ML models include those generally referred to as intellectual tasks, such as classification, prediction, natural language processing, etc.

Although AI and ML are explained separately, ML is a technology included in AI. In ML, instead of being explicitly programmed for a specific task, systems can improve their performance over time by identifying patterns and making inferences from training data. Typically, the generation of ML models includes data collection, model training, and model inference. Data collection involves gathering and preprocessing data to be used for training and inference. Model training involves developing and validating models using the collected data. Model inference involves applying the trained models to new data to generate new output data and perform tasks.

Machine learning includes various types of learning methods such as supervised learning, unsupervised learning, reinforcement learning, semi-supervised learning, self-supervised learning, transductive learning, transfer learning, meta learning, and the like. These types of learning methods can be appropriately selected according to the embodiments. Unless otherwise specified, the application of types not mentioned in this description is not precluded. Additionally, the structure of ML models may vary depending on the embodiments and learning methods, and is not limited to the methods disclosed. Furthermore, ML includes deep learning, which uses models that include neural networks. Deep learning models may include, for example, deep neural networks (DNNs), convolutional neural networks (CNNs), etc.

It should be noted that the AI/ML models presented hereinafter are examples and are not limited to the illustrated AI/ML models. They can be modified or altered by using different AI or ML algorithms. The configuration of the neural network is not limited to the configuration disclosed in the present disclosure and can be modified.

Further, it shall be noted that, descriptions of example embodiments of the present disclosure may include terms and names defined in one or more standard organizations, such as the Open Radio Access Network (O-RAN) Alliance, the 3rd Generation Partnership Project (3GPP) standard organization, the European Telecommunications Standards Institute (ETSI) standard organization, and the like. For instance, the terms “CU”, “DU”, “RLC”, “MAC ”, “MAC CE”, “E2”, “F1”, and the like, as well as the associated features and operations, are to be interpreted as consistent with those specified in one or more technical specifications, unless being described otherwise.

As described above, in a Radio Access Network (RAN), a Distributed Unit (DU) may receive a data packet from a Central Unit (CU) and schedule the transmission of the data packet over the air interface. Generally, the DU may host a Radio Link Control (RLC) layer and a Media Access Control (MAC) layer, both of which are involved in the scheduling of the data packet transmission. In the related art, when the RLC layer receives the data packet from the CU (e.g., from the CU-User Plane (CU-UP), etc.), the RLC may store the data packet in a queue (or a buffer) and request the MAC layer to grant or allocate radio resources for transmitting the data packet. For instance, the RLC layer may request the MAC layer for a grant based on the buffer status, the incoming queue size, and/or a fixed packet length. The MAC layer may evaluate the information provided by the RLC layer alongside the radio channel conditions (and Quality of Service (QoS) requirements, in some scenarios), and then provide the grant or the allocation of the radio resources based thereon. Accordingly, the downlink data packet will be scheduled over the air interface based on the granted resources (e.g., number of grant bits/bytes, etc.). For instance, the RLC layer may utilize the grated resources to segment the data packet into suitable sizes, and then forward the segmented data packets to the physical layer for transmission over the air interface to a User Equipment (UE).

In the related art, the DU may perform downlink data steering to optimize the scheduling and transmission of the data packet based on various factors. For instance, the DU may determine the priority level of the data packet, prioritize high-priority traffic, adapt transmission parameters based on channel conditions, and the like.

The downlink data steering in the related art, however, does not address the challenges of managing variable data packet numbers and sizes. Specifically, when the RLC layer receives a variable number of data packets (each data packet with different sizes, etc.), it is challenging for the RLC layer to compute and request an accurate amount of grant bytes needed for each transmission, since such operations are time-consuming and computationally intensive. In this regard, if the RLC layer overestimates the required grant bytes and requests more resources than necessary, the MAC layer may allocate and provide more resources than the required grant, leading to excessive padding bytes in the data packet and eventually resulting in unnecessary bandwidth consumption. Conversely, if the RLC layer underestimates the required grant bytes and requests fewer resources than necessary, the MAC layer may allocate and provide fewer resources than the required grant, leading to the underutilization of available radio resources, especially under favorable channel conditions, thereby reducing overall network efficiency.

Example embodiments of the present disclosure, as described in the following, provide devices, systems, methods, and the like, that effectively and efficiently enhance the downlink data steering, and ultimately address the shortcomings of the related art systems and methods.

Specifically, example embodiments of the present disclosure provide systems, devices, methods, operations, and the like, that enable a Control Component to dynamically provide, to an RLC layer of a device (e.g., a DU, etc.), a suggested amount of grant bytes (that is computed based on information of the RLC layer, MAC layer, and downlink data packets associated with the device) whenever a downlink data packet arrives (or will be arriving) to the device. Accordingly, the RLC layer may request the MAC layer for a first amount of grant bytes that is based on the suggested amount of grant bytes. This first amount of grant bytes provides a baseline grant bytes that may vary according to the suggested amount of grant bytes, avoiding the overestimation and underestimation of grant bytes when requesting the MAC layer and thereby avoiding excessive padding bytes, unnecessary bandwidth consumption, and underutilization of radio resources.

Furthermore, by implementing the example embodiments, if there is any pending transmission(s) during the scheduling of transmission(s), the RLC layer may prioritize the transmission(s) that has a higher priority, ensuring that high-priority traffic will be scheduled and transmitted with minimal delay (or without delay). Further, the Control Component may, upon determining that the channel condition is below a threshold, control the device to reduce the associated data packet receiving rate and/or guide the RLC layer to request for less grant bytes to the MAC layer, thereby optimizing the internal resource utilization of the DU, improving processing efficiency, and saving air interface resources.

Ultimately, example embodiments of the present disclosure may provide enhanced downlink data steering by enabling efficient and effective scheduling of downlink data transmission. It is contemplated that features, advantages, and significances of example embodiments described hereinabove are merely a portion of the present disclosure, and are not intended to be exhaustive or to limit the scope of the present disclosure. Further descriptions of the features, components, configuration, operations, and implementations of the example embodiments of the present disclosure are provided in the following.

### Example System Architecture

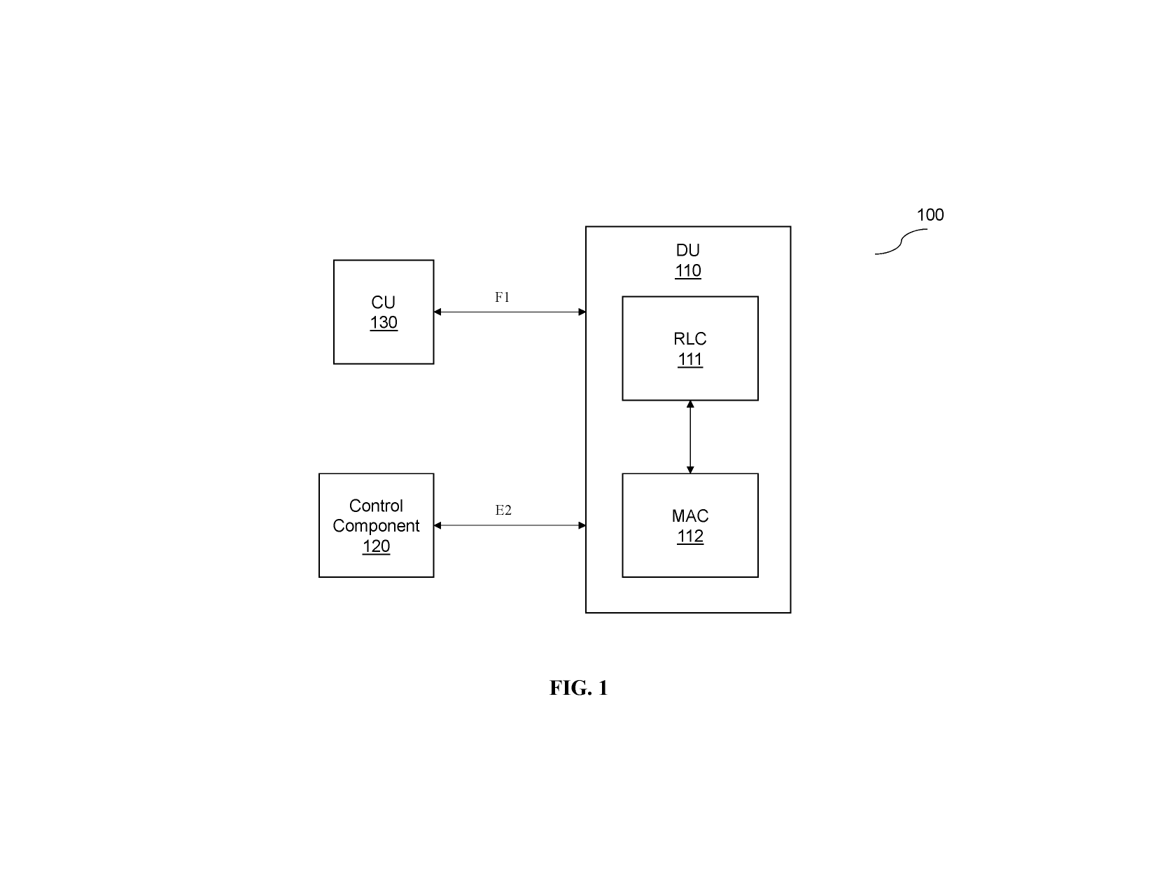

FIG. 1 illustrates a diagram of an example system 100, according to one or more example embodiments. As shown in FIG. 1, the system 100 may include a Distributed Unit (DU) 110, a Control Component 120, and a Central Unit (CU) 130. Further, the DU 110 may include an RLC layer 111 and a MAC layer 112.

It is contemplated that the system 100 in FIG. 1 is merely an example and the configuration of the system may vary according to the requirements or implementations. For instance, in some example embodiments, multiple CUs may be implemented, multiple Control Components may be implemented, the DU 110 may include other components (such as other protocol layers like a Packet Data Convergence Protocol (PDCP) layer, a Physical layer, a component for managing the communication between the DU 110 and the Control Component 120, etc.), and the like, without departing from the scope of the present disclosure. Further, in some example implementations, the component(s) of system 100 may be referred to in a different terminology. For instance, in some example implementations, the “MAC layer” may be referred to as “MAC scheduler”, the “DU” may be referred to as “NRDU” when the DU is associated with 5G New Radio (NR), and the like.

Furthermore, one or more of the components in system 100, such as the DU 110 (as well as the RLC layer 111 and MAC layer 112 associated therewith), Control Component 120, and CU 130, may be implemented in software form, hardware form, or a combination thereof. For instance, these components may each be implemented as a virtualized or containerized network function, and may be deployed on a device or hardware component. In this regard, descriptions such as “Control Component may perform an operation,” “Control Component may be configured to perform an operation,” “a device may be configured to implement the Control Component to perform an operation,” and the like, may be interpreted as “a device (or a hardware component) may execute computer-readable instructions or programming codes associated with the Control Component to perform an operation associated with the Control Component,” and the like.

According to example embodiments, the DU 110 may further include one or more additional components that may be implemented or configured to manage the communication between the DU 110 and the Control Component 120. For instance, the DU 110 may further include an E2 Control (E2C) Manager, which is a logical function that handles control-plane operations on the E2 interface. The E2C manager may be implemented in the software form and may be configured to manage the communications between the DU 110 and the Control Component 120. For instance, the E2C Manager may receive, from the RLC layer, information associated with the RLC layer 111 and MAC layer 112, and then forward said information to the Control Component 120. By leveraging the E2C Manager to control the communications between the DU 110 and Control Component 120, the data, information, and the like, may be communicated in a standardized and consistent manner, regardless of underlying vendor specifics. Further, by assigning the management of communication between the DU 110 and Control Component 120 to the E2C Manager, the RLC layer 111 is relieved of managing additional signaling and reporting tasks, thereby enhancing the performance and efficiency of the RLC layer 111.

Generally, the DU 110 may be configured to interoperate with the Control Component 120 to perform one or more methods/operations to enhance downlink data steering when scheduling transmission of a downlink data packet obtained/received from the CU 130. Specifically, the DU 110 may be communicatively coupled to the Control Component 120 via an E2 interface and may be configured to periodically (or continuously) provide information associated with the RLC layer 111 and information associated with the MAC layer 112 to the Control Component 120. In addition, the DU 110 may be communicatively coupled to the CU 130 via an F1 interface and may be configured to obtain a downlink data packet (e.g., user data packet, control data packet, etc.) therefrom.

According to example embodiments, the DU 110 may periodically (or continuously) update or indicate, to the Control Component 120 via the E2 interface, information or metrics associated with the RLC layer (e.g., information associated with the data packet such as the queue depth that indicates a packet size in bytes and/or the queue depth size that indicates the number of data packet in a slot, information associated with a transmission pending in the buffer such as the information of transmission of a MAC Control Element (MAC CE), information of transmission of a Status Protocol Data Unit (PDU), information of a retransmission of a data packet, information of transmission of a new segmented data packet, and information of transmission of a new data packet, etc.) and information or metrics associated with the MAC layer (e.g., Radio Network Temporary Identifier (RNTI), Channel Quality Indicator (CQI), Block Error Rate (BLER), Modulation and Coding Scheme (MCS), Bearer Identifier (ID), Physical Resource Blocks (PRBs) Status such as “available” and “used”, etc.). As further described below, said information may be utilized by the Control Component 120 to determine a suggested amount of grant bytes that the RLC layer 111 may request to the MAC layer 112.

Whenever a data packet arrives at (or is scheduled to be sent to) the DU 110, the Control Component 120 may determine a suggested amount of grant bytes which the RLC layer can request to the MAC layer 112, and then send a control message that includes the associated information to the RLC layer 111. Specifically, the Control Component 120 may determine the suggested amount of grant bytes based on the information provided by the DU 110 (i.e., information associated with the RLC layer 111 and information associated with the MAC layer 112) and information of downlink data packets associated with the DU 110, such as downlink data packets that have been provided to the DU 110 in the past, downlink data packets that are in the process of routing to the DU 110, and/or downlink data packets that will be provided to the DU 110.

According to example embodiments, the Control Component 120 may implement one or more AI/ML models or features to infer (or may communicate with another component that implements the AI/ML model(s)/feature(s) to obtain) details or information of the downlink data packets associated with the DU 110, such as volume, flow characteristics, QoS requirements, and the like. In some example implementations, the Control Component 120 may be implemented in software form and hosted in a network component. For instance, the Control Component 120 (or one or more operations associated therewith) may be implemented by an xApp that is managed by a Near-Real-Time (Near-RT) RAN Intelligent Controller (RIC). In this regard, the Control Component 120 (i.e., the Near-RT RIC or the associated xApp) may communicate with a Non-Real-Time (Non-RT) RIC (or an rApp associated therewith) that implements an AI/ML model(s)/feature(s) to infer the information associated with the downlink data packet(s), and then obtain said information therefrom. Alternatively, the Control Component 120 may include both the Non-RT RIC (or the associated rAPP) and the Near-RT RIC (or the associated xApp). Accordingly, whenever the Control Component 120 determines that the RLC layer 111 needs to request the MAC layer 112 for a grant (e.g., the scheduling of a data packet transmission is required, etc.), the Control Component 120 may determine the suggested amount of grant bytes, based on the information of the downlink data packets and the information provided by the DU 110 (i.e., the information associated with the RLC layer 111 and the information associated with the MAC layer 112).

Upon receiving the suggested amount of grant bytes from the Control Component 120, the RLC layer 111 may compute a first amount of grant bytes based on the suggested amount of grant bytes provided by the Control Component 120. The first amount of grant bytes may refer to the amount of grant bytes that the RLC layer 111 required for the transmission of the data packet and any other pending transmission(s) (if any), without accounting for the channel condition or based on an assumption that the channel condition is optimal. Subsequently, the RLC layer 111 may request the MAC layer 112 to grant or allocate the first amount of grant bytes.

Upon receiving the request from the RLC layer 111, the MAC layer 112 may determine a second amount of grant bytes, based on the first amount of grant bytes and at least one real-time (or near-real-time) channel condition. In this regard, the channel condition may refer to one or more status or conditions, such as noise level, interference, signal quality, etc., of at least one of a wired communication channel and a wireless communication channel. In some example embodiments, the channel condition may include one or more air interface radio conditions, which define the status or condition(s) of a wireless radio communication channel.

According to example embodiments, the second amount of grant bytes provided by the MAC layer 112 may be the same or different from the first amount of grant bytes. Specifically, if the channel condition is optimal, the MAC layer 112 may allocate the full, first amount of grant bytes as requested by the RLC layer 111. Conversely, if the channel condition is non-optimal, the MAC layer 112 may determine, based on the requested first amount of grant bytes and the channel condition, the second amount of grant bytes which may be lower than the first amount of grant bytes. Subsequently, the MAC layer 112 may provide the second amount of grant bytes to the RLC layer 111.

Upon receiving the second amount of grant bytes from the MAC layer 112, the RLC layer 111 may update the Control Component 120 about the amount of grant bytes provided by the MAC layer 112, such that the Control Component 120 may take into consideration such information in determining the suggested amount of grant bytes in the next iteration or operation.

Concurrently or subsequently, the RLC layer 111 may schedule the transmission of the data packet and the pending transmission(s) (if any) based on the second amount of grant bytes. Specifically, if there is no pending transmission, the RLC layer 111 may use the full, second amount of grant bytes to schedule the transmission of the data packet. On the other hand, if there is a pending transmission, the RLC layer 111 may prioritize the scheduling of the transmission that has a higher priority. For instance, if the transmission of the data packet has a higher priority than the pending transmission, the RLC layer 111 may utilize the second amount of grant bytes to schedule the transmission of the data packet and then utilize the remaining grant bytes to schedule the pending transmission, and vice versa. Such an approach ensures that, in the event that the second amount of grant bytes is smaller than the first amount of grant bytes, the transmission of high priority will be prioritized.

According to example embodiments, the RLC layer 111 may utilize a predefined priority order to schedule the transmission of the downlink data packet(s). The predefined priority order may be, for example: transmission of a MAC CE has the highest priority, followed by transmission of a Status PDU (e.g., RLC Automatic Repeat Request (ARQ) level Acknowledgment (ACK)/Negative Acknowledgment (NACK), etc.), retransmission of a data packet, transmission of a segmented data packet, and lastly transmission of a new data packet. The predefined priority order may be included in a priority table and be utilized by the RLC layer 111 when required.

In the scenarios where the second amount of grant bytes provided by the MAC layer 112 is lower than the requested first amount of grant bytes (e.g., the channel condition is non-optimal), there is a possibility that the RLC layer 111 is not able to schedule the transmission of the data packet, if there is a pending transmission that has a higher priority level than the transmission of the data packet. In this regard, since the Control Component 120 receives the information of the RLC layer 111 (which includes information of the pending transmission(s) and the data packet) and the information of the MAC layer 112 (which includes information of the measure channel condition), the Control Component 120 may control the DU110 to adjust the data packet receiving rate according to the channel condition and/or the transmission status (e.g., pending transmission(s), new transmission(s), etc.) of the RLC layer 111.

For instance, based on determining that the channel condition is below a threshold (e.g., the channel condition is bad), the Control Component 120 may request the DU 110 to reduce the data packet receiving rate. Upon receiving the request to reduce the data packet receiving rate, the DU 110 (or the MAC layer 112 associated therewith) may implement an appropriate mechanism, such as the Downlink Data Delivery Status (DDDS) mechanism and the like, to reduce the data packet receiving rate. Additionally or alternatively, based on determining that the channel condition is below a threshold (e.g., the channel condition is bad), the Control Component 120 may request the RLC layer 111 to request a smaller amount of grant bytes to the MAC layer 112, according to the pending transmission(s), the transmission of the new data packet, and the priority levels associated therewith. It is contemplated that the Control Component 120 may also request the DU 110 to increase the data packet receiving rate and/or request the RLC layer 111 to request a higher amount of grant bytes, in a similar manner.

In view of the above, example embodiments of the present disclosure provide a system, a device, a mechanism, and the like, that enhance the downlink data steering. Specifically, example embodiments enable the Control Component 120 to dynamically provide to the RLC layer 111 a suggested amount of grant bytes (that is computed based on information of the RLC layer 111, MAC layer 112, and downlink data packets associated with the DU 110) whenever a downlink data packet arrives (or will be arriving) to the DU 110. Accordingly, the RLC layer 111 may request the MAC layer 112 for a first amount of grant bytes that is based on the suggested amount of grant bytes. This first amount of grant bytes provides a baseline grant bytes that may vary according to the suggested amount of grant bytes, avoiding the overestimation and underestimation of grant bytes when requesting the MAC layer 112 and thereby avoiding excessive padding bytes, unnecessary bandwidth consumption, and underutilization of radio resources.

Furthermore, during the scheduling of transmission(s), if there is any pending transmission(s), the RLC layer 111 may prioritize the transmission(s) that has a higher priority, ensuring that high-priority traffic will be scheduled and transmitted with minimal delay (or without delay). Further, the Control Component 120 may, upon determining that the channel condition is below a threshold, control the DU 110 to reduce the data packet receiving rate and/or guide the RLC layer 111 to request for less grant bytes to the MAC layer 112, thereby optimizing the internal resource utilization of the DU 110, improving processing efficiency, and saving air interface resources.

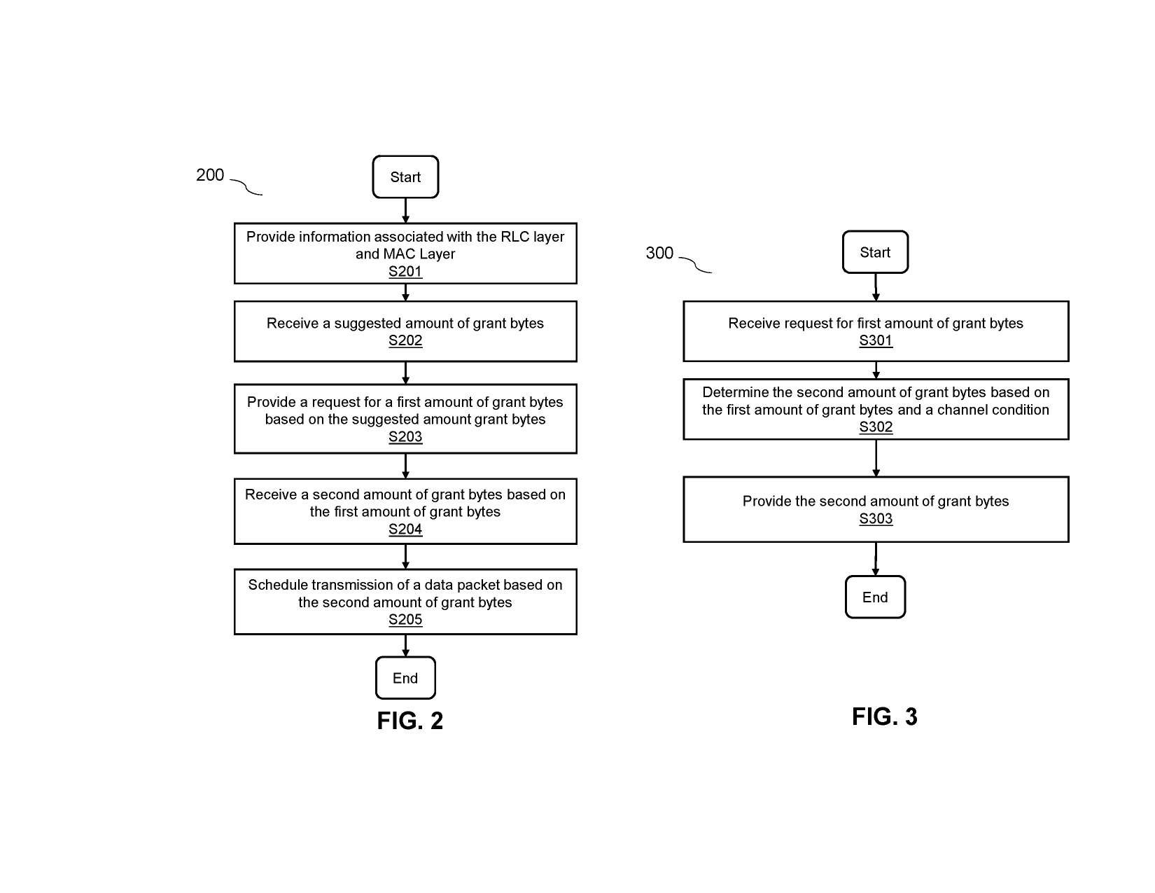

Ultimately, example embodiments of the present disclosure may provide enhanced downlink data steering by enabling efficient scheduling of downlink data transmission. It is contemplated that features, advantages, and significances of example embodiments described hereinabove with reference to FIG. 1 are merely a portion of the present disclosure, and are not intended to be exhaustive or to limit the scope of the present disclosure. Further descriptions of example methods and operations associated with the components of system 100 (e.g., DU 110, Control Component 120, etc.) are provided below with reference to FIGS. 2 to 8.

### Example Methods and Operations

As described above, the components in FIG. 1 (e.g., DU 110, Control Component 120, etc.) may be configured to interoperate with each other and perform one or more methods and operations to enhance downlink data steering. In the following, descriptions of several example methods and the associated operations are provided.

One or more operations (and the data involved therein) may be similar to those described above with reference to FIG. 1, thus it may be understood that the above-described operations and data may be similarly applied to the operations described hereinbelow (unless described otherwise) and redundant descriptions associated therewith may be omitted for conciseness.

For descriptive purposes, the methods and operations may be mainly described as being performed by one or more specific components, although it can be understood that, in actual implementations, another related component(s) may perform similar/related operations, without departing from the scope of the present disclosure. For instance, an operation of the RLC layer (or a device that implements the RLC layer) receiving a suggested amount of grant bytes from a Control Component may indicate or suggest an operation of the Control Component providing the suggested amount of grant bytes to the RLC layer (or the device that implements the RLC layer), and the like.

According to example embodiments, one or more components of the system in FIG. 1 may be implemented in one or more devices or hardware components, and one or more methods and operations described hereinbelow may be performed by the one or more devices/hardware components. For instance, the DU 110 (as well as the RLC layer 111, MAC layer 112, and E2C Manager associated therewith) and/or the Control Component 120 may be implemented in a device that includes a processor and a memory storage (or any other suitable storage mediums), wherein the memory storage may include computer-executable instructions or programming codes which, when being executed by the processor, cause the processor to perform one or more operations associated therewith. Descriptions of an example device that may implement the example embodiments are provided below with reference to FIG. 11.

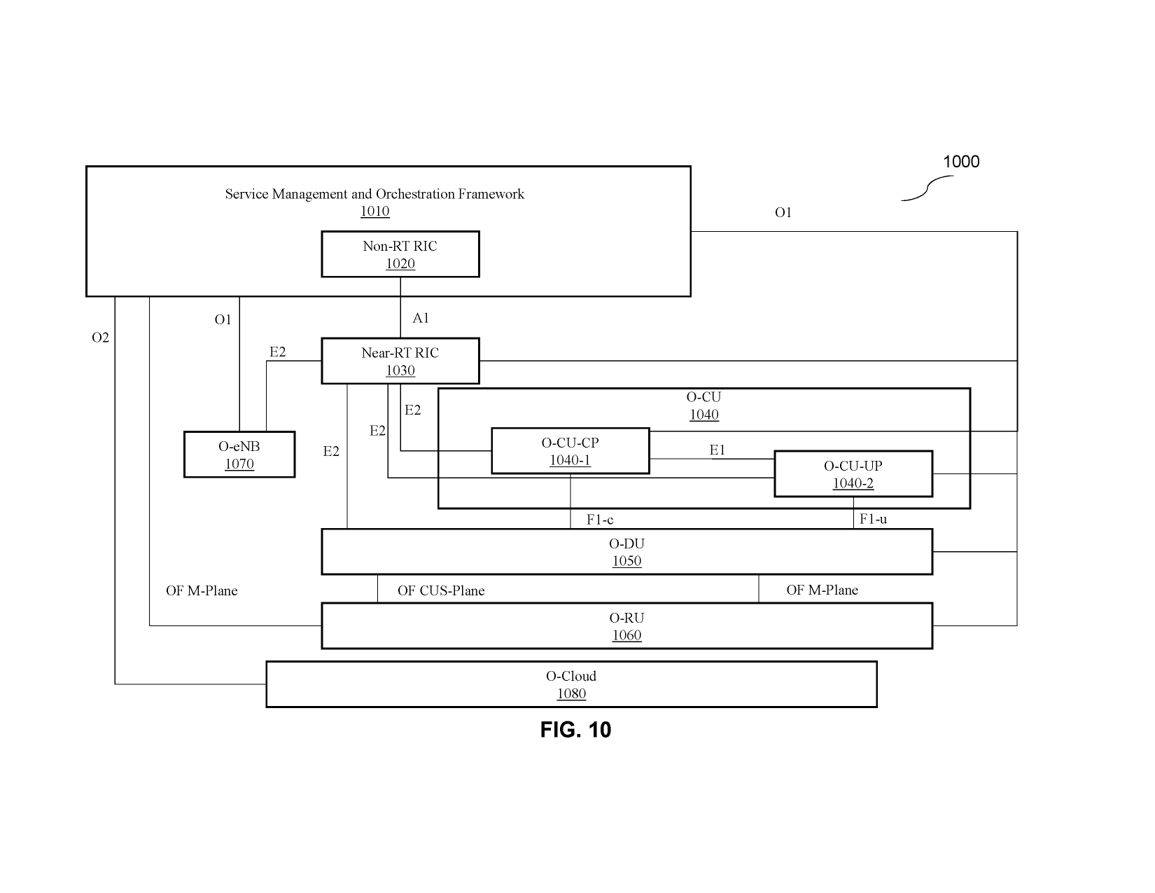

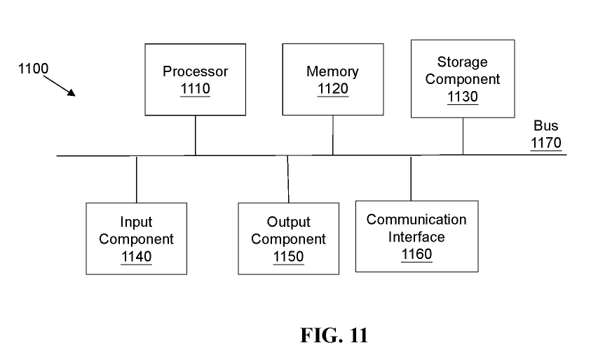

FIG. 2 illustrates a block diagram of an example method 200 for scheduling transmission of a data packet, according to one or more example embodiments. One or more operations of method 200 may be implemented by a device that includes an RLC layer and a MAC layer (e.g., a DU described above with reference to FIG. 1, a device that implements the DU, an Open RAN Distributed Unit (O-DU) described below with reference to FIG. 10, a device that implements the O-DU, etc.). Specifically, the device may be configured to implement the RLC layer to perform (or the RLC layer may be configured to perform) one or more operations of method 200.

Referring to FIG. 2, at operation S201, the device may be configured to implement the RLC layer to provide, to a Control Component, information associated with the RLC layer and information associated with the MAC layer. In some example implementations, the device may be configured to implement the RLC layer to continuously (or periodically) provide said information to the Control Component for at least a predetermined period of time.

According to example embodiments, the device may include a DU (or a device that implements a DU) of a telecommunication network and the Control Component may include a RIC (e.g., Near-RT RIC, a combination of Near-RT RIC and Non-RT RIC, etc.) or an application managed by the RIC (e.g., an xApp managed by the Near-RT RIC, etc.). In this regard, the device may be configured to implement the RLC layer to provide said information to the Control Component via an E2 interface.

According to example embodiments, the device may be configured to implement the RLC layer to receive, from the MAC layer, the information associated with the MAC layer. Accordingly, the device may be configured to implement the RLC layer to combine the information associated with the RLC layer with the information associated with the MAC layer, and then provide the combined information to the Control Component.

According to example embodiments, the device may further include an E2C Manager. In this regard, the device may implement the RLC layer to provide the information associated with the RLC layer and information associated with the MAC layer to the E2C Manager, and the device may further implement the E2C manager to provide said information to the Control Component.

According to example embodiments, the information associated with the RLC layer may include information associated with at least one of: a data packet, a pending transmission (e.g., information associated with a buffer that stores the data packet for transmission, etc.), and a count of data and/or bytes the RLC layer can handle in one Transmission Time Interval (TTI). On the other hand, the information associated with the MAC layer may include information associated with at least one of: a channel condition and a QoS requirement. In this regard, the information associated with the data packet may include information associated with at least one of: a queue depth that indicates a size of the data packet in bytes, and a queue depth size that indicates the number of data packet(s) in a slot. Further, the information associated with the pending transmission may include at least one of: information associated with transmission of a MAC CE, information associated with transmission of a Status PDU, information associated with retransmission of a data packet, information associated with transmission of a new segmented data packet, and information associated with transmission of a newly received data packet. The information of associated with the pending transmission may indicate the status of the buffer such as the pending transmission(s) and transmission(s) to be scheduled. Furthermore, the information associated with the channel condition may include at least one of: an RNTI, a CQI, a BLER, an MCS, a Bearer ID, and a PRB Status.

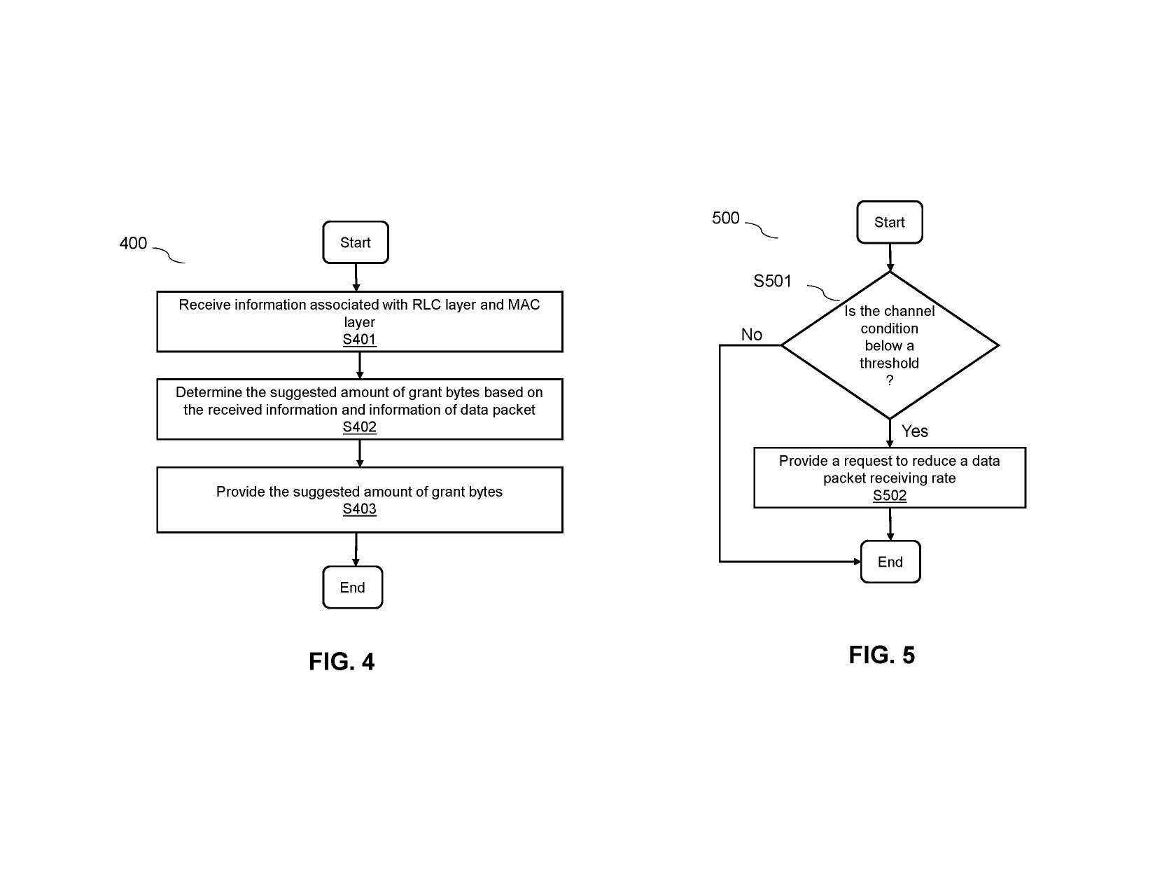

At operation S202, the device may be configured to implement the RLC layer to receive, from the Control Component, a suggested amount of grant bytes based on the information associated with the RLC layer and the information associated with the MAC layer. Example operations associated with the determination of the suggested amount of grant bytes (by the Control Component) are described below with reference to FIG. 4.

According to example embodiments in which the device includes a DU (or a device that implements a DU) and the Control Component includes a RIC (or an application managed by the RIC), the device may be configured to implement the RLC layer to receive the suggested amount of grant bytes from the Control Component via the E2 interface. According to example embodiments in which the device further includes an E2C Manager, the device may implement the E2C Manager to receive the suggested amount of grant bytes from the Control Component, and then further implement the RLC layer to receive the suggested amount of grant bytes from the E2C Manager.

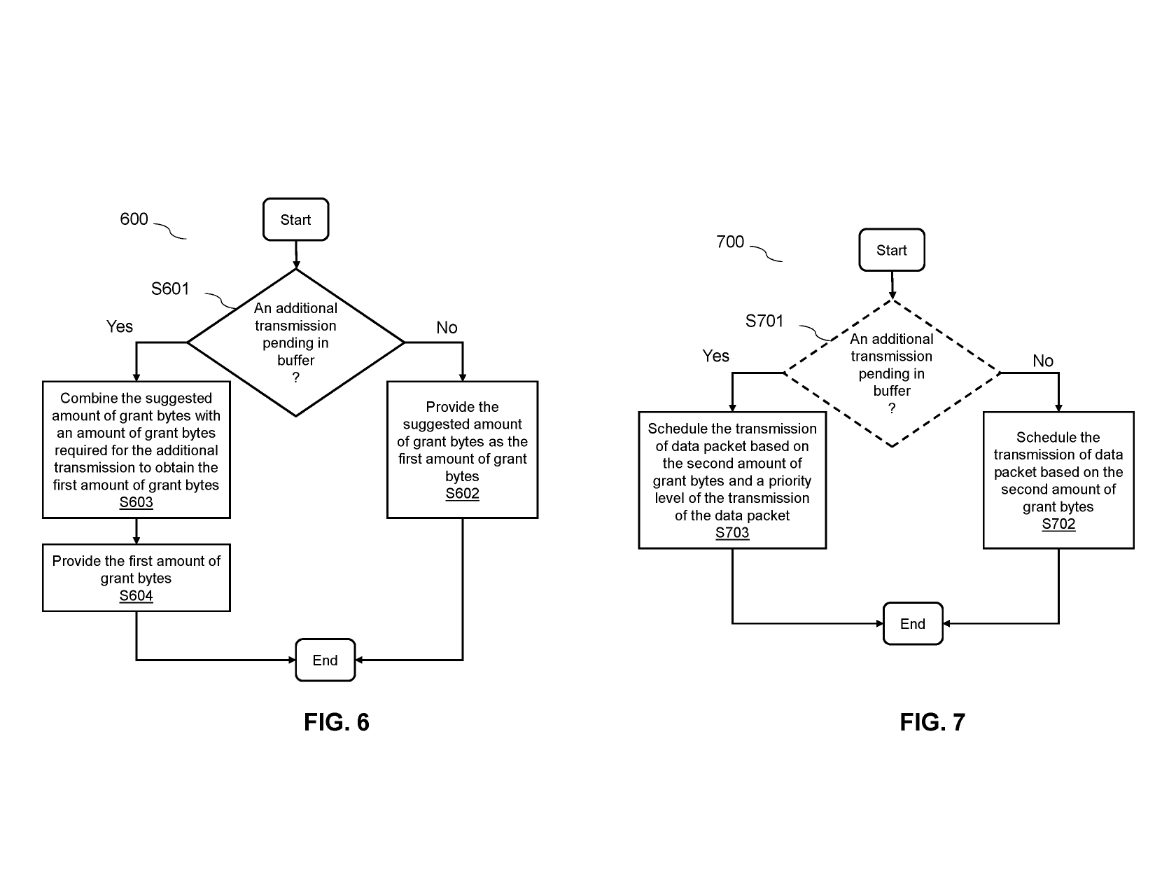

At operation S203, the device may be configured to implement the RLC layer to provide, to the MAC layer, a request for a first amount of grant bytes based on the suggested grant bytes. Example operations associated with the determination of the first amount of grant bytes (by the RLC layer) are described below with reference to FIG. 6.

At operation S204, the device may be configured to implement the RLC layer to receive, from the MAC layer, a second amount of grant bytes based on the first amount of grant bytes. Example operations associated with the determination of the second amount of grant bytes (by the MAC layer) are described below with reference to FIG. 3.

At operation S205, the device may be configured to implement the RLC layer to schedule the transmission of a data packet based on the second amount of grant bytes. Example operations associated with the scheduling of the transmission (by the RLC layer) are described below with reference to FIG. 7.

FIG. 3 illustrates a block diagram of an example method 300 for providing a second amount of grant bytes, according to one or more example embodiments. One or more operations of method 300 may be implemented by the device associated with FIG. 2. Specifically, the device may be configured to implement the MAC layer to perform (or the MAC layer may be configured to perform) one or more operations of method 300 to interoperate with one or more operations of method 200. For instance, operation S301 may be performed in response to operation S203, operation S303 may be performed to initiate operation S204, and the like.

Referring to FIG. 3, at operation S301, the device may be configured to implement the MAC layer to receive, from the RLC layer, a request for the first amount of grant bytes.

At operation S302, the device may be configured to implement the MAC layer to determine, based on the first amount of grant bytes and a channel condition, the second amount of grant bytes.

According to example embodiments, the second amount of grant bytes may be the same or different from the first amount of grant bytes requested by the RLC layer. Specifically, the device may be configured to implement the MAC layer to determine a real-time (or near-real-time) channel condition, and then determine whether an adjustment on the first amount of grant bytes is needed. For instance, if it is determined that the channel condition is optimal and it is possible to allocate the first amount of grant bytes without any adjustment, the device may be configured to implement the MAC layer to allocate the full, first amount of grant bytes as requested by the RLC layer. Conversely, if it is determined that the channel condition is non-optimal, the MAC layer 112 may determine, based on the requested first amount of grant bytes and the channel condition, the second amount of grant bytes which may be lower than the first amount of grant bytes.

At operation S303, the device may be configured to implement the MAC layer to provide, to the RLC layer, the second amount of grant bytes.

FIG. 4 illustrates a block diagram of an example method 400 for providing a suggested amount of grant bytes, according to one or more example embodiments. One or more operations of method 400 may be implemented by a Control Component (or a device that implements the Control Component). Specifically, the Control Component may be configured to perform (or the device may implement the Control Component to perform) one or more operations of method 400 to interoperate with the device that implements the RLC layer to perform one or more operations of method 200. For instance, operation S401 may be performed in response to operation S201, operation S403 may be performed to initiate operation S202, and the like.

Referring to FIG. 4, at operation S401, the Control Component may be configured to receive, from a device (i.e., a device that includes an RLC layer and a MAC layer, such as the device that performs method 200 and method 300), information associated with the RLC layer and information associated with the MAC layer. In some example implementations, the Control Component may be configured to continuously (or periodically) receive said information from the device for at least a predetermined period of time.

According to example embodiments, the Control Component may include a RIC (e.g., Near-RT RIC, a combination of Near-RT RIC and Non-RT RIC, etc.) or an application managed by the RIC (e.g., an xApp managed by the Near-RT RIC, etc.), and the device may include a DU of a telecommunication network. In this regard, the Control Component may be configured to receive the information associated with the RLC layer and the information associated with the MAC layer from the device via the E2 interface. According to example embodiments, the device may include an E2C Manager, and the Control Component may be configured to receive the information associated with the RLC layer and the information associated with the MAC layer from the E2C Manager.

The examples of information associated with the RLC layer and information associated with the MAC layer have been described above with reference to FIGS. 1 and 2, thus redundant descriptions associated therewith may be omitted below for conciseness.

At operation S402, the Control Component may be configured to determine, based on the received information and information associated with the data packet, a suggested amount of grant bytes. According to example embodiments, operation S402 may be initiated when the Control Component detects that a data packet arrives at (or is scheduled to be sent to) the device. The Control Component may perform any suitable operations to detect the data packet, such as: obtaining a report from the device (which includes information of the newly received data packet(s), etc.), obtaining a report from a CU (e.g., CU 130) when the CU receives new data packet(s) from the Core Network and is routing the new data packet(s) to the device, and the like.

According to example embodiments, the Control Component may be configured to determine the suggested amount of grant bytes based on the information received at operation S401 (i.e., information associated with the RLC layer and information associated with the MAC layer) and information of downlink data packets associated with the device, such as downlink data packets that have been provided to the device in the past, downlink data packets that are in the process of routing to the device, and/or downlink data packets that will be provided to the device. This information of downlink data packets may include the information of the data packet that the device is scheduling transmission for (at operation S205).

According to example embodiments, the Control Component may implement one or more AI/ML models or features to infer (or may communicate with another component that implements the AI/ML model(s)/feature(s) to obtain) details or information associated with the downlink data packets, such as volume, flow characteristics, QoS requirements, and the like. According to example embodiments in which the Control Component includes a Near-RT RIC (or an xApp managed by the Near-RT RIC), the Control Component may communicate with a Non-RT RIC (or a device that implements the Non-RT RIC) that implements an AI/ML model(s)/feature(s) to infer the information associated with the downlink data packets, and then obtain said information therefrom. According to example embodiments in which the Control Component includes both the Non-RT RIC (or the associated rAPP) and the Near-RT RIC (or the associated xApp), the Control Component may be configured to implement the Non-RT RIC to infer the information of the downlink data packets and then implement the Near-RT RIC to determine the suggested amount of grant bytes.

At operation S403, the Control Component may be configured to provide, to the device, the suggested amount of grant bytes. According to example embodiments in which the Control Component includes a RIC (e.g., Near-RT RIC, a combination of Near-RT RIC and Non-RT RIC, etc.) or an application managed by the RIC (e.g., an xApp managed by the Near-RT RIC, etc.) and the device includes a DU, the Control Component may be configured to provide the suggested amount of grant bytes to the device via the E2 interface. According to example embodiments in which the device includes an E2C Manager, the Control Component may be configured to provide the suggested amount of grant bytes to the device via the E2C Manager.

In some example implementations, the Control Component may be configured to perform one or more additional operations concurrently with, subsequent to, or prior to one or more operations of method 400. For instance, subsequent to operation S403, the Control Component may be configured to obtain, from the device, information of an amount of grant bytes that is allocated by the MAC layer of the device (i.e., the second amount of grant bytes). Accordingly, the Control Component may utilize said information in operation S402 for the next iteration, when determining another suggested amount of grant bytes associated with another data packet. Additionally or alternatively, the Control Component may control the device to adjust the associated data packet receiving rate according to the channel condition. Example operations associated therewith are described below with reference to FIG. 5.

FIG. 5 illustrates a block diagram of an example method 500 for reducing data packet receiving rate, according to one or more example embodiments. One or more operations of method 500 may be implemented by a Control Component (or a device that implements the Control Component), which may be the Control Component (or the associated device) that performs the operations of method 400. Specifically, the Control Component may be configured to perform (or the device may implement the Control Component to perform) one or more operations of method 500, concurrently with, subsequent to, or prior to one or more operations of method 400.

Referring to FIG. 5, at operation S501, the Control Component may be configured to determine, based on the received information (e.g., information received at operation S401, etc.), whether the channel condition is below a threshold. The threshold may be predefined by a user (e.g., a network operator) to indicate a minimum channel condition. Namely, when the channel condition is below the threshold, the Control Component may determine that the channel condition is below an acceptable range (e.g., the channel condition is non-optimal/bad) and thus the data packet receiving rate of the device shall be reduced in order to optimize the resource utilization in the device. Operation S501 may be performed subsequent to operation S401.

Based on determining that the channel condition is not below the threshold (i.e., the channel condition is within an acceptable range), method 500 may be terminated. Alternatively, method 500 may return to operation S501, such that the Control Component may repeatedly perform method 500 for at least a predetermined period of time.

On the other hand, based on determining that the channel condition is below the threshold (i.e., the channel condition is below the acceptable range), the Control Component may be configured to provide, to the device, a request to reduce a data packet receiving rate. The request may include a request or instruction to initiate a DDDS mechanism to reduce the data packet receiving rate of the device.

In some example embodiments, in alternative to or in addition to controlling the device to adjust the associated data packet receiving rate, based on determining that the channel condition is below the threshold (i.e., the channel condition is below the acceptable range), the Control Component may also be configured to guide the RLC layer of the device to reduce the amount of grant bytes requested to the MAC layer for at least a predetermined period of time.

FIG. 6 illustrates a block diagram of an example method 600 for providing a first amount of grant bytes, according to one or more example embodiments. One or more operations of method 600 may be part of operation S203 of method 200, and may be performed by the same device that implements method 200. Specifically, the device may be configured to implement the RLC layer to perform (or the RLC layer may be configured to perform) one or more operations of method 600 to provide a first amount of grant bytes at operation S203.

Referring to FIG. 6, at operations S601, the device may be configured to implement the RLC layer to determine whether there is an additional transmission pending in a buffer of the device. In this regard, the additional transmission may include at least one of: transmission of a MAC CE, transmission of a Status PDU, retransmission of a data packet, transmission of a new segmented data packet, and transmission of a newly received data packet (which may refer to the data packet for which the RLC layer schedules transmission or a different data packet). The additional transmission, when available, may be stored in the buffer (e.g., a queue) and waiting for transmission scheduling. Thus, if there is any additional transmission pending in the buffer, the RLC layer of the device may need to adjust the suggested amount of grant bytes to accommodate the grant bytes required for the additional transmission(s), before requesting the grant bytes to the MAC layer of the device.

Referring still to FIG. 6, based on determining that there is no additional transmission pending in the buffer (i.e., no adjustment on the suggested amount of grant bytes is required), method 600 may proceed to operation S602, at which the device may be configured to implement the RLC layer to provide, to the MAC layer, the suggested amount of grant bytes as the first amount of grant bytes.

On the other hand, based on determining that there is an additional transmission pending in the buffer, method 600 may proceed to operation S603, at which the device may be configured to implement the RLC layer to combine the suggested amount of grant bytes with an amount of grant bytes required for the additional transmission, thereby obtaining the first amount of grant bytes.

Subsequently, at operation S604, the device may be configured to implement the RLC layer to provide, to the MAC layer, the first amount of grant bytes.

FIG. 7 illustrates a block diagram of an example method 700 for scheduling transmission of a data packet, according to one or more example embodiments. One or more operations of method 700 may be part of operation S205 of method 200, and may be performed by the same device that implement method 200. Specifically, the device may be configured to implement the RLC layer (or the RLC layer may be configured to) perform one or more operations of method 700 to schedule transmission of the data packet at operation S205.

Referring to FIG. 7, at operations S701, the device may be configured to implement the RLC layer to determine whether there is an additional transmission pending in a buffer of the device. This operation may be similar to operation S601 in FIG. 6, thus additional descriptions associated therewith may be omitted herein for conciseness. According to example embodiments, operation S701 may be optional, and the device may be configured to implement the RLC layer to utilize the result of operation S601.

Based on determining that there is no additional transmission pending in the buffer, method 700 may proceed to operation S702, at which the device may be configured to implement the RLC layer to schedule the transmission of the data packet based on the second amount of grant bytes. Specifically, the device may be configured to implement the RLC layer to utilize the full, second amount of grant bytes to schedule the transmission of the data packet. For instance, the RLC layer may be configured to segment the data packet into multiple PDUs that fit within the second amount of grant bytes. Once the data packet is segmented into PDUs, the RLC layer may provide the PDUs to the MAC layer for the actual transmission over the air interface.

On the other hand, based on determining that there is an additional transmission pending in the buffer, method 700 may proceed to operation S703, at which the device may be configured to implement the RLC layer to schedule the transmission of the data packet based on the second amount of grant bytes and a priority level of the transmission of the data packet. For instance, the RLC layer may determine which transmission has a higher priority level and prioritize scheduling of the transmission that has the higher priority level. For instance, if the transmission of the data packet has a higher priority than the pending transmission, the RLC layer may utilize the second amount of grant bytes to schedule the transmission of the data packet and then utilize the remaining grant bytes (if any) to schedule the pending transmission, and vice versa. In a scenario where the transmission of the data packet has the same priority as the additional pending transmission (e.g., both transmissions are for transmitting a MAC CE, etc.), the RLC layer may prioritize the transmission of a data packet(s) that arrives at an earlier time.

According to example embodiments, the device may be configured to implement the RLC layer to utilize a predefined priority table that defines priority orders to schedule the transmission of the downlink data packet(s). The predefined priority order may be, for example: transmission of a MAC CE has the highest priority, followed by transmission of a Status PDU (e.g., RLC ARQ level ACK/NACK, etc.), retransmission of a data packet, transmission of segmented data packet, and lastly transmission of a new data packet.

According to example embodiments, the device (e.g., DU, etc.) associated with methods 200, 300, 600, and 700 may further include an additional component, such as an E2C Manager, that manages the communication between the RLC layer of the device and the Control Component (associated with methods 400 and 500). Example operations associated with the E2C Manager are described below.

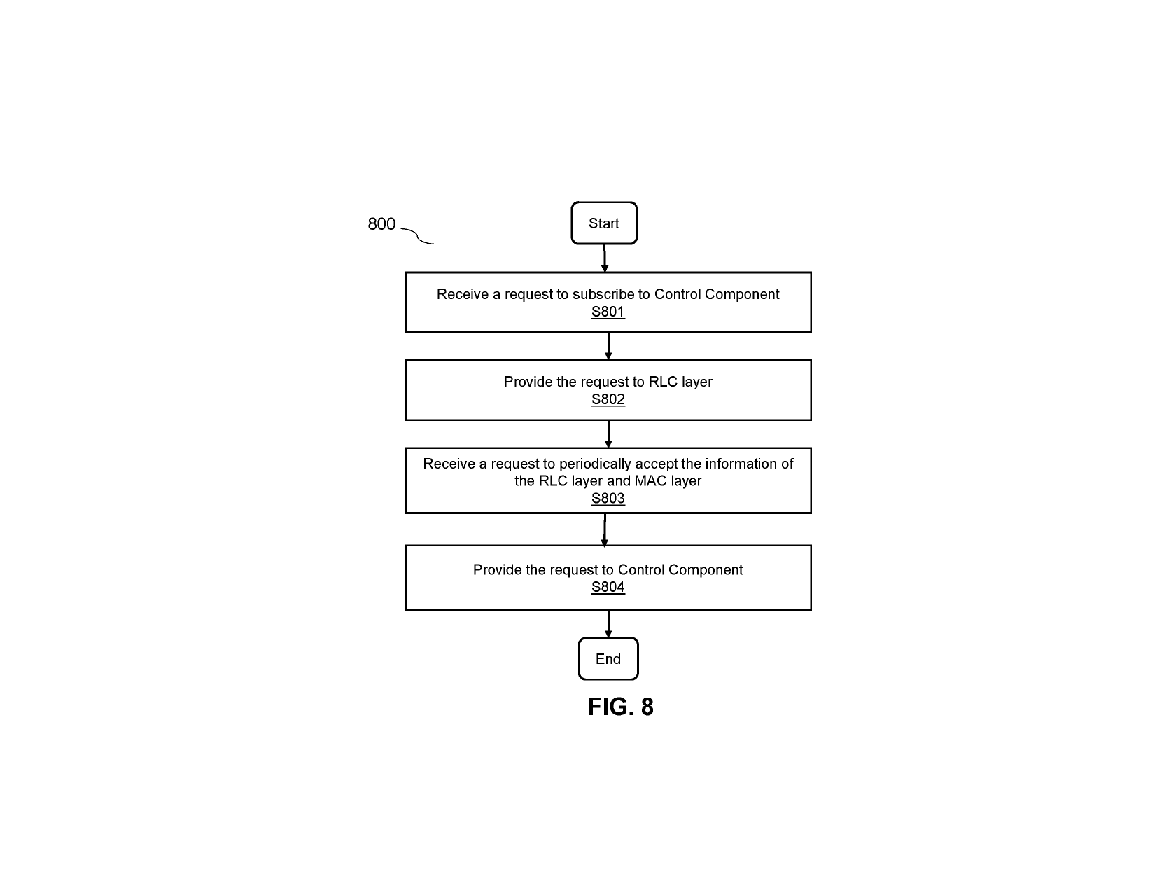

FIG. 8 illustrates a block diagram of an example method 800 for managing communication between the RLC layer and the Control Component, according to one or more example embodiments.

Referring to FIG. 8, at operation S801, the device may be configured to implement the E2C manager to receive, from the Control Component, a request to subscribe to the Control Component. This operation may be triggered or initiated by the Control Component to request the device to subscribe to the Control Component, when the Control Component is newly added or implemented to the network. Additionally or alternatively, this operation may be triggered or initiated by the device when the device is newly implemented or connected to the network. In this regard, the request may be provided by the Control Component to the device to request the device (particularly, the associated RLC layer and MAC) to provide information or indication as requested.

At operation S802, the device may be configured to implement the E2C manager to provide, to the RLC layer, the request to subscribe to the Control Component.

At operation S803, the device may be configured to implement the E2C manager to receive, from the RLC layer, a request to periodically accept the information of the RLC layer and the information of the MAC layer. In this regard, the request itself may include the information of the RLC layer and the information of the MAC layer. Further, the request may request the E2C Manager to periodically accept said information from the RLC layer and provide the aforementioned information to the Control Component.

At operation S804, the device may be configured to implement the E2C manager to provide, to the Control Component, a request to periodically accept the information of the RLC layer and the information of the MAC layer. In this regard, the request may request the Control Component to periodically accept said information from the E2C Manager.

In view of the above, example embodiments of the present disclosure provide method and operations performable or implementable by one or more components, devices, systems, and the like, to enhance the downlink data steering.

Specifically, the method and operations in FIG. 2 may be automatically implemented by a device (e.g., a DU, an O-DU, a device that implements the DU/O-DU, etc.) to enable the RLC layer of the device to request and obtain appropriate grant bytes to schedule transmission of a data packet.

The method and operations in FIG. 3 may be automatically implemented by the device to enable the MAC layer of the device to determine and allocate an appropriate amount of grant bytes, taking into consideration of the requested grant bytes and the real-time (or near-real-time) channel condition.

The method and operations in FIG. 4 may be automatically implemented by a Control Component (e.g., a Near-RT RIC, a combination of Near-RT RIC and Non-RT RIC, an application associated with the Near-RT RIC, etc.) to determine and provide an appropriately amount of grant bytes that can be suggested to the device, based on the information provided by the device and information of data packets associated with the device. Accordingly, the substantive computations are not required at the RLC layer of the device since the resource-heavy computational operations (e.g., continuously determining the suggested amount of grant bytes, inferencing the information of the data packets with AI/ML model(s) or feature(s), etc.) are offloaded to the Control Component.

The method and operations in FIG. 5 may be automatically implemented by the Control Component to control the device to adjust the associated data packet receiving rate according to the channel condition, thereby optimizing resource utilization in the device, improving processing efficiency, and conserving air interface resources.

The method and operations in FIG. 6 may be automatically implemented by the device to enable the RLC layer of the device to determine and request an appropriate amount of grant bytes taking into consideration of the buffer status, thereby ensuring that the amount of grant bytes requested to the MAC layer encompasses the grant bytes required for any other transmission(s) pending in the buffer.

The method and operations in FIG. 7 may be automatically implemented by the device to enable the RLC layer of the device to appropriately schedule the transmission of a data packet taking into consideration the buffer status, thereby ensuring that transmission(s) that have a higher priority level would be prioritized, scheduled and transmitted with minimal delay (or without delay).

The method and operations in FIG. 8 may be automatically implemented by the device to enable the E2C Manager of the device to manage communication between the device (particularly, the RLC layer of the device) and the Control Component, thereby offloading the communication management from the RLC layer and enhance the performance of the RLC layer.

To this end, methods and operations of example embodiments may be implemented to avoid overestimation and underestimation of grant bytes when the RLC layer of the device requests the MAC layer for a grant, thereby avoiding excessive padding bytes, unnecessary bandwidth consumption, and underutilization of radio resources. Furthermore, the risk of service disruption may be reduced (since high-priority traffic will be scheduled and transmitted with minimal delay or without delay), the internal resource utilization of the device may be optimized, the processing efficiency of the device may be improved, and the air interface resources may be conserved. Ultimately, example embodiments of the present disclosure may provide enhanced downlink data steering by enabling efficient scheduling of downlink data transmission.

It is contemplated that, the methods, operations, advantages, and significances described above with reference to FIGS. 2 to 8 are merely examples and the scope of the present disclosure should not be limited thereto. Specifically, one or more operations in FIGS. 2 to 8 may be performed differently, fewer or additional operations may be involved, additional advantages may be achieved, and the like, without departing from the scope of the present disclosure.

### Example Use Cases

Several example use cases, according to one or more example embodiments, are described in the following. It can be understood that one or more components in FIG. 1, one or more methods and operations in FIGS. 2 to 8, as well as features and data described above with reference therewith, may involve or be applicable in the use cases described herein. Thus, redundant descriptions associated therewith may be omitted below for conciseness.

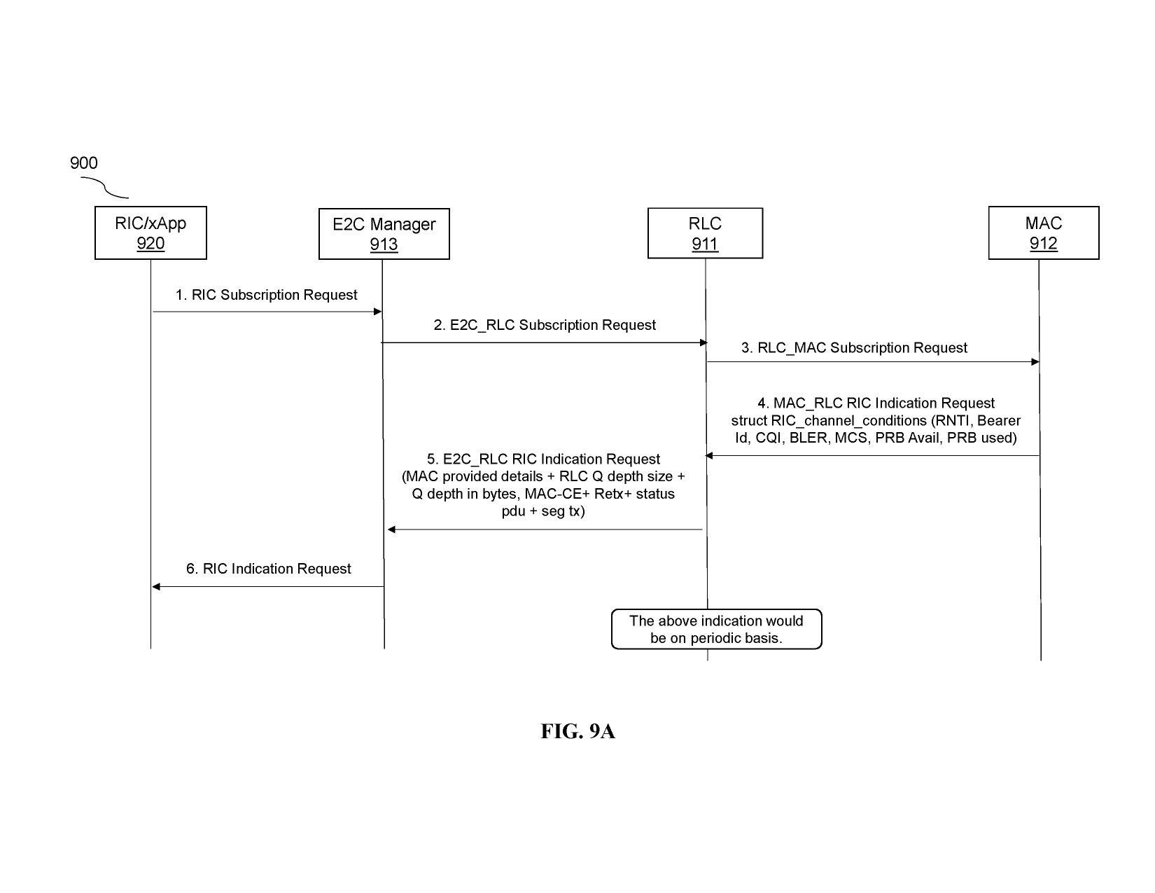

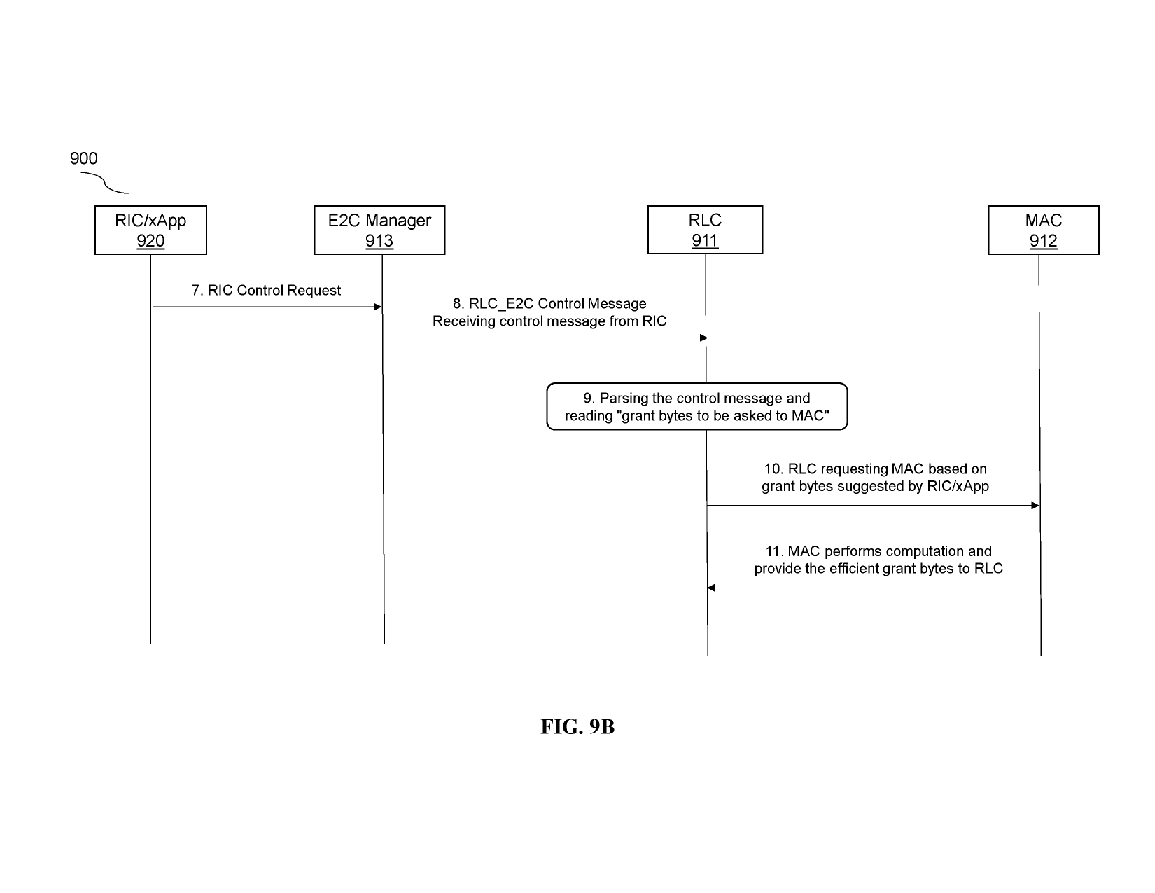

FIGS. 9A and 9B illustrate a flow diagram of an example use case 900, according to one or more example embodiments. In this example use case, it is assumed that a RIC and/or an xApp (RIC/xApp) 920 is utilized, and a DU includes an RLC layer 911, a MAC layer 912, and an E2C Manager 913. The RIC/xApp 920 may be an example of the Control Component 120 in FIG. 1, while the RLC layer 911 and the MAC layer 912 may be similar to the RLC layer 111 and MAC layer 112 in FIG. 1, respectively. Further, as described above, the E2C Manager 913 may be implemented in the DU (e.g., in the form of a communication interface, a software application, and the like) to manage the interface communication with any suitable components via the E2 interface. In this example use case, the E2C Manager 913 is implemented to manage the communication between the RIC/xApp 920 and the components of the DU (i.e., the RLC layer 911 and the MAC layer 912).

Referring to FIG. 9A, at step 1, the RIC/xApp 920 may provide, to the E2C Manager 913, a request to subscribe to the RIC/xApp 920. This step may be triggered or initiated by the RIC/xApp 920 to request the existing DU to subscribe to the RIC/xApp 920, when the RIC/xApp 920 is newly added or implemented to the network. Additionally or alternatively, this step may be triggered or initiated by the DU when the DU is newly added/implemented to the network. This subscription request may be provided to the DU to request the DU (particularly, the associated RLC layer 911 and MAC 912) to provide information or indication as requested. For descriptive and illustrative purposes, the subscription request being forwarded by the RIC/xApp 920 to the E2C Manager 913 is labeled herein as “RIC Subscription Request”.

Accordingly, at step 2, the E2C Manager 913 may receive the RIC Subscription Request (similar to operation S801 in method 800) and subscribe to the RIC/xApp 920. In addition, the E2C Manager 913 may provide the subscription request (or generate and provide a new subscription request) to the RLC layer 911 (similar to operation S802 in method 800). For descriptive and illustrative purposes, the subscription request being provided by the E2C Manager 913 to the RLC layer 911 is labeled herein as “E2C_RLC Subscription Request”.

Upon receiving the subscription request from the E2C Manager 913, at step 3, the RLC layer 911 may subscribe to the RIC/xApp 920 and provide the subscription request (or generate and provide a new subscription request) to the MAC layer 912. For descriptive and illustrative purposes, the subscription request being provided by the RLC layer 911 to the MAC layer 912 is labeled herein as “RLC_MAC Subscription Request”.

Upon receiving the subscription request from the RLC layer 911, the MAC layer 912 may subscribe to the RIC/xApp 920 and generate, based on the subscription request, an indication request that includes indication or information requested by the RIC/xApp 920, such as information associated with the channel conditions (e.g., RNTI, Bearer ID, CQI, BLER, MCS, PRB status, etc.). Accordingly, at step 4, the MAC layer 912 may provide the indication request to the RLC layer 911. This indication request may request the RLC layer 911 to periodically accept the indication from the MAC layer 912 and provide an indication that includes the aforesaid information to the RIC/xApp 920. For descriptive and illustrative purposes, the indication request being provided by the MAC layer 912 to the RLC layer 911 is labeled herein as “MAC_RLC RIC Indication Request”.

Upon receiving the indication request from the MAC layer 912, the RLC layer 911 may generate, based on the subscription request (from the RIC/xApp 920) and the indication request (from the MAC layer 912), an indication request that includes indication or information requested by the RIC/xApp 920 and the indication/information in the indication request provided by the MAC layer 912. For instance, the RLC layer 911 may generate an indication request that includes information associated with the RLC layer 911 and information associated with the MAC layer 912. Examples of said information have been described above with reference to one or more of FIGS. 1 to 8, thus redundant descriptions associated therewith are omitted below for conciseness. Accordingly, at step 5, the RLC layer 911 may provide the indication request to the E2C Manager 913. This indication request may request the E2C Manager 913 to periodically accept the indication from the RLC layer 911 and provide an indication that includes the aforesaid information to the RIC/xApp 920. For descriptive and illustrative purposes, the indication request being sent by the RLC layer 911 to the E2C Manager 913 is labeled herein as “E2C_RLC RIC Indication Request”.

The E2C Manager 913 may receive the indication request from the RLC layer 911 (similar to operation S803 in method 800). Accordingly, at step 6, the E2C Manager 913 may provide the indication request to the RIC/xApp 920 via the E2 interface (similar to operation S804 in method 800). This indication request may include the first indication (that includes the information associated with the RCL layer 911 and the MAC layer 912) and request the RIC/xApp 920 to periodically accept the indication from the DU (via the E2C Manager 913, etc.).

At this stage, the subscription stage is completed, and the components of the DU (e.g., RLC layer 911, MAC layer 912, E2C Manager 913) may periodically provide the indication/information of the RLC layer 911 and MAC layer 913 to update the RIC/xApp 920 (similar to operation S201 in method 200). Similarly, the RIC/xApp 920 may periodically receive said indication/information from the DU (similar to operation S401 in method 400)

Referring next to FIG. 9B, whenever the RIC/xApp 920 determines an incoming data packet that is arriving (or has arrived at) the DU, the RIC/xApp 920 may determine, based on the information of the data packet (obtained from a Non-RT RIC or the associated rApp, etc.) and the indication provided by the E2C Manager 913, a suggested amount of grant bytes the RLC layer 911 may request to the MAC layer 912 (similar to operation 402 in method 400).

Accordingly, at step 7, the RIC/xApp 920 may generate a control request and provide the control request to the E2C Manager 913. This control request may instruct or request the E2C Manager to receive and forward a control message that includes information of the suggested amount of grant bytes to the RLC layer 911. For descriptive and illustrative purposes, the control request being provided by the RIC/xApp 920 to the E2C Manager 913 is labeled herein as “RIC Control Request”.

Upon receiving the control request from the RIC/xApp 920, the E2C Manager 913 may accept the control request and notify the RIC/xApp 920. Subsequently, the RIC/xApp 920 may provide the control message (that includes information of the suggested amount of grant bytes) to the E2C Manager 913 (similar to operation S403 in method 400). Accordingly, at step 8, the E2C Manager 913 may provide the control message to the RLC layer 911. The control message may instruct or notify the RLC layer 911 to request an amount of grant bytes for the incoming data packet(s) based on the suggested amount of grant bytes provided by the RIC/xApp 920. For descriptive and illustrative purposes, the control message being provided by the E2C Manager 913 to the RLC layer 911 is labeled herein as “RLC_E2C Control Message”.

Upon receiving the control message, at step 9, the RLC layer 911 may process the control message (e.g., parse the control message and read the content thereof) and determine a first amount of grant bytes based thereon (similar to operations S601 to S603 in method 600). For instance, the RLC layer 911 may combine the suggested amount of grant bytes with any additional grant byte(s) required for additional transmissions (e.g., transmission of MAC CE, transmission of Status PDU, retransmission of a data packet, transmission of segmented data pending in the buffers, etc.) to thereby determine the first amount of grant bytes, and then generate the grant request that includes the information of the first amount of grant bytes.

At step 10, the RLC layer 911 may send the grant request to the MAC layer 912 to request the MAC layer for allocating the first amount of grant bytes (similar to operation S203 in method 200 and operations S602/S604 in method 600).

Upon receiving the grant request from the RLC layer 911, the MAC layer 912 may determine a second amount of grant bytes based on, for example, the channel condition and the first amount of grant bytes defined in the grant request (similar to operations S301 to S302 in method 300). In some example implementations, the MAC layer 912 may further take into consideration additional factors, such as QoS requirements and the like, when determining the second amount of grant bytes.

Accordingly, at step 11, the MAC layer 912 may allocate and provide the second amount of grant bytes to the RLC layer 911 (similar to operation S303 in method 300). Subsequently, the RLC layer 911 may receive the second amount of grant bytes (similar to operation S204 in method 200) and then process the data packet (e.g., segmenting the data packet, etc.) and schedule the transmission of the data packet according to the second amount of grant bytes (similar to operation S205 in method 200 and operations S701 to S703 in method 700).

As a non-limiting example, assume that the RLC layer 911 receives 200 packets of downlink data packets, each of which has a size of 500 bytes. Without implementing the example embodiments, the grant requested by the RLC layer 911 would be based purely on the queue depth (that defines the total number of data packets) and the queue depth in bytes (that defines the total number of bytes). In this regard, assuming that the channel conditions are the optimal conditions, the MAC layer 912 may provide 100k grant bytes to the RLC layer 911 for transmitting the downlink data packets. In this regard, although the MAC layer 912 has provided 100k grant bytes to the RLC layer 911, the RLC layer 911 may not be able to fully utilize the provided grant bytes due to its limitation on encoding the data packets. For instance, assuming that the RLC layer 911 has a peak encoding rate of 150 packets, the maximum grant bytes that may be utilized by the RLC layer 911 to encode the data packets and schedule the transmission thereof would be 75k grant bytes (i.e., 150*1200 bytes) and the remaining 25k grant bytes would be added as padding bytes. In this scenario, the RLC layer 911 has requested more grant bytes than it could utilize, and the MAC layer 912 has provided more grant bytes than required, leading to a wastage of radio resources and bandwidth consumption due to the increased padding bytes.

By implementing the example embodiments, the RLC layer 911 and the MAC layer 912 periodically (or continuously) provide indication or information associated therewith to the RIC/xApp 920. Further, the RIC/xApp 920 may obtain information of the incoming data packet(s) and determine a suggested amount of grant bytes that the RLC layer 911 can request to the MAC layer 912, based on the indication/information provided by the RLC layer 911 and MAC layer 912, as well as the information of the downlink data packets associated with the DU. In some example implementations, the RIC/xApp 920 may also be configured to load an MCS index table for Physical Downlink Shared Channel (PDSCH), the MCS index table may include information, such as Quadrature Amplitude Modulation (QAM), Transport Block Size (TBS), Modulation order, MCS indexes, and the like, that may be utilized for the determination of the suggested grant bytes. Accordingly, the RIC/xApp 920 may provide a suggested amount of grant bytes (which may be a nearby value of grant bytes) to be requested to the MAC layer 912 and suggest the RLC layer 911 consider the suggested amount of grant bytes when requesting the grant to the MAC layer 912, thereby avoiding padding.

As another non-limiting example, assuming that the channel condition is bad, the MAC layer 912 may provide a smaller amount of grant bytes than requested by the RLC layer 911. For instance, the RLC layer 911 may request 100k grant bytes for scheduling the transmission of new downlink data packets, but the MAC layer 912 may only provide 50k grant bytes due to the bad channel conditions. In this regard, if the RLC layer 911 has any higher priority transmissions (e.g., transmission of MAC-CE, Status PDU, etc.), the RLC layer 911 would not be able to schedule the new transmission.

By implementing example embodiments, the RLC layer 911 may utilize a predefined priority order to schedule multiple transmissions of downlink data packets (similar to operation S703 in method 700), such as: transmission of a MAC CE has the highest priority, followed by the transmission of a Status PDU (RLC ARQ level ACK/NACK), retransmission of data, transmission of new segmented data, and lastly transmission of new data packet. The predefined priority order may be included in a priority table and be utilized by the RLC layer 911 when required.

Further, in this example use case (where the channel condition is bad), the RIC/xApp 920 may also control the RLC 911 to reduce the packet receiving rate (similar to operations S501 to S502 in method 500). In addition, the RIC/xApp 920 may also guide the RLC 911 to request for smaller amount of grant bytes to the MAC layer 912 according to the status of the pending transmission and scheduled retransmission. Accordingly, the utilization of the DU’s internal resources may be optimized, improving the processing efficiency and conserving the network resources.

It is contemplated that the above-described use cases are merely examples, and the scope of the present disclosure should not be limited thereto. Specifically, the example use cases merely illustrate the potential implementations of the example embodiments, and it can be understood that any suitable variation may be applicable, without departing from the scope of the present disclosure.

### Example Network Architecture

In some example implementations, example embodiments of the present disclosure may be implemented in a telecommunication network based on an Open RAN (O-RAN) architecture. FIG. 10 illustrates a block diagram of an O-RAN architecture 1000, according to one or more example embodiments.

RAN functions in the O-RAN architecture may be controlled and optimized by a RIC. The RIC may be a software-defined component that implements modular applications to facilitate the multivendor operability required in the O-RAN system, as well as to automate and optimize RAN operations. As shown in FIG. 10, the RIC may be divided into two types: a Non-RT RIC 1020 and a Near-RT RIC 1030.

The Non-RT RIC 1020 may be the control point of a non-real-time control loop and may operate on a timescale greater than 1 second within a Service Management and Orchestration (SMO) framework 1010. Its functionalities may be implemented through modular applications called rApps, and may include: providing policy-based guidance and enrichment across the A1 interface, which is the interface that enables communication between the Non-RT RIC and the Near-RT RIC; performing data analytics; AI/ML training and inference for RAN optimization; and/or recommending configuration management actions over the O1 interface, which may be the interface that connects the SMO to RAN managed elements (e.g., Near-RT RIC 1030, O-RAN Centralized Unit (O-CU) 1040, O-RAN Distributed Unit (O-DU) 1050, etc.).

The Near-RT RIC 1030 may operate on a timescale between 10 milliseconds and 1 second and may be coupled with the O-DU 1050, the O-CU 1040 ( which may disaggregated into the O-CU control plane (O-CU-CP) 1040-1 and the O-CU user plane (O-CU-UP) 1040-2), and an open evolved NodeB (O-eNB) 1070 via the E2 interface. The Near-RT RIC 1030 may use the E2 interface to control the underlying RAN elements (E2 nodes/network functions (NFs)) over a near-real-time control loop. The Near-RT RIC 1030 may monitor, suspend/stop, override, and control the E2 nodes (O-CU 1040, O-DU 1050, and O-eNB 160) via policies. For example, the Near-RT RIC 1030 may set policy parameters on activated functions of the E2 nodes. Further, the Near-RT RIC 1030 may host xApps to implement functions such as quality of service (QoS) optimization, mobility optimization, slicing optimization, interference mitigation, load balancing, security, etc.

Here, the O-CU-CP 1040-1 and the O-CU-UP 1040-2 may be coupled to each other via the E1 interface, and may be coupled to the O-DU 1050 via the F1-c interface and F1-u interface, respectively. Further, the O-RU 1060 may be coupled to the O-DU 1050 via the Open Fronhaul (OF) Control (C), User (U), Synchronization (S), and Management (M) Planes, and may be coupled to the SMO 110 via the OF M-Plane.

The two types of RICs work together to optimize the O-RAN. For example, the Non-RT RIC 1020 may provide the policies, data, and AI/ML models enforced and used by the Near-RT RIC 1030 for RAN optimization, and the Near-RT RIC 1030 may return policy feedback (i.e., how the policy set by the Non-RT RIC 1020 works). In some example embodiments, the Non-RT RIC 1020 may implement or host one or more applications (rApps) to perform one or more associated applications, and the Near-RT RIC 1030 may implement or host one or more applications (xApps) to perform one or more associated applications. According to example embodiments, the Non-RT RIC 1020 (or the associated rApp) may implement one or more AI/ML models to obtain or infer information of downlink data packets arriving at the O-CU 1040 and eventually arriving at the O-DU 1050. Accordingly, the Near-RT RIC 1030 (or the associated xApp) may obtain the information of the downlink data packets from the Non-RT RIC 1020 (or the associated rApp) via the A1 interface.

Further, as mentioned above, the Non-RT RIC 1020 may be located within the SMO framework 1010, which manages and orchestrates RAN elements. Specifically, the SMO 1010 may manage and orchestrate what is referred to as the O-Ran Cloud (O-Cloud) 1080. The O-Cloud 1080 may be a collection of physical RAN nodes that host the RICs, O-CUs, and O-DUs, the supporting software components (e.g., the operating systems and runtime environments), and the SMO 1010 itself. In other words, the SMO 1010 may manage the O-Cloud 1080 from within. The O2 interface may be the interface between the SMO 1010 and the O-Cloud 1080 it resides in. Through the O2 interface, the SMO 1010 may provide infrastructure management services (IMS) and deployment management services (DMS).

The O-CU 1040, the O-DU 1050, and the O-RU 1060 may constitute a base station, such as a gNodeB (gNB) of 5G NR, a node in Next Generation Radio Access Network (NG-RAN), a base station of a 6G network, and the like. On the other hand, the O-eNB 1070 may refer to a 4G LTE version of the O-RAN-compliant node (e.g., an eNB that adheres to the O-RAN architecture).

In some example implementations, the system may include a plurality of O-DUs 1050, and the O-CU 1040 may be communicatively coupled to the plurality of O-DUs. Similarly, the system may include a plurality of O-RUs 1060, and the O-DU(s) 1050 may be communicatively coupled to the plurality of O-RUs via one or more of the O-FH C/U/S/M plane interfaces.

According to example embodiments, the O-CU 1040 and the O-DU 1050 may be defined in software form and may be deployed in one or more network nodes. For instance, the O-CU 1040 and the O-DU 1050 may be deployed in one or more servers in the form of virtualized network function (VNF), containerized and/or cloud-native function (CNF), and the like. According to example embodiments, the O-CU 1040 and the O-DU 1050 may be deployed in the same network node (e.g., same server) and/or may be located at a similar geographical location (e.g., be deployed in different servers in the same data center). According to example embodiments, the O-CU 1040 and the O-DU 1050 may be deployed in different network nodes and/or may be located at different geographical locations. For instance, the O-CU 1040 may be deployed in one or more central servers (i.e., servers in one or more central data centers), and the O-DU 1050 may be deployed in one or more edge servers (i.e., servers in one or more edge data centers).

Further, a single O-DU 1050 may host or serve multiple network cells formed by multiple O-RUs. According to example embodiments, the O-DU 1050 may implement various radio technologies, such as massive multiple-input multiple-output (MIMO), beamforming, and the like, to optimize radio communication among the multiple cells and the O-CU 1040. In some example implementations, the O-DU 1050 may concurrently host or serve hundreds (e.g., 256, 512, etc.) of cells at a time.

The O-RU 1060 may be a physical node that converts radio signals from antennas to digital signals that can be transmitted over the Front Haul to the O-DU 1050. In this regard, a network cell described herein may correspond to one or more radio units responsible for providing wireless coverage and signal transmission within the network cell. The network cell may include a macro cell, a micro cell, a pico cell, a femto cell, and/or any other suitable type of network cell. Each of the cells may have an associated coverage area, in which at least one O-RU 1060, at least one antenna system, and any other suitable type of transport network element (TNE), may be deployed therein.

According to example embodiments, the O-CU-UP 1040-2 may obtain (from a Core Network, etc.) a downlink data packet and forward the same to the O-DU 1050 via the F1-u interface. The capability and activity of the O-CU-UP 1040-2 (as well as the downlink data packet involved therein, in some example implementations) is monitored by the Non-RT RIC 1020 (via the O1 interface). Accordingly, the Non-RT RIC 1020 (or an associated rApp) may implement an AI/ML model or feature to infer the information of the downlink data packets associated with the O-DU 1050 (e.g., number of downlink data packets that may be obtained by the O-CU-UP 1040-2 and provided to the O-DU 1050 in the future, etc.) and provide such information to the Near-RT RIC 1030 (or an associated xApp). In this regard, since the Near-RT RIC 1030 (or an associated xApp) may be configured to periodically (or continuously) receive indication/information of the O-DU 1050 (e.g., indications/information of the associated RLC layer and MAC layer), the Near-RT RIC 1030 (or an associated xApp) may effectively and efficiently determine the suggested amount of grant bytes that the RLC layer of the O-DU 1050 may request to the associated MAC layer. Accordingly, the Near-RT RIC 1030 (or an associated xApp) may provide the information of the suggested amount of grant bytes (in the form of a control message, etc.) to the O-DU 1050 via the E2 interface, such that the O-DU 1050 may utilize such information for efficiently and effectively scheduling the transmission of the downlink data packet, thereby enhancing the downlink data steering.

### Example of Device

One or more components of the system of the example embodiments (e.g., Control Component, DU, etc.), as well as the operations associated therewith, may be implemented in one or more devices or hardware components. For instance, one or more components/operations of the system may be implemented in one or more devices like a server(s), and the like.

In the following, descriptions of a device in which the example embodiments may be implemented are provided. It is contemplated that one or more features, operations, and methods described above may be performed by the device. For instance, the one or more operations or methods associated with an RLC layer and a MAC layer of a DU may be performed by at least one processor of the device upon executing machine-readable instructions or computer-readable instructions stored in a memory or a storage component of the device.

FIG. 11 illustrates an embodiment of a device 1100. As shown in FIG. 11, the device 1100 may include a processor 1110, a memory 1120, a storage component 1130, an input component 1140, an output component 1150, a communication interface 1160, and a bus 1170.

The processor 1110, as used herein, means any type of computational circuit that may comprise hardware elements and software elements. The processor 1110 may be embodied as a multi-core processor, a single core processor, or a combination of one or more multi-core processors and/or one or more single core processors, a distributed processing system, or the like. The processor 1110 may be a Central Processing Unit (CPU), a graphics processing unit (GPU), an accelerated processing unit (APU), an application-specific integrated circuit (ASIC), or another type of processing component.

Memory 1120 includes a non-transitory computer readable medium. Memory 1120 includes a random-access memory (RAM), a read only memory (ROM), and/or another type of dynamic or static storage device (e.g., a flash memory, a magnetic memory, and/or an optical memory) that stores information and/or instructions for use by processor 1110. The memory 1120 comprises machine-readable instructions which are executable by the processor 1110. These machine-readable instructions when executed by the processor 1110 cause the processor 1110 to perform one or more method steps of an embodiment described above.

Storage component 1130 stores information and/or software related to the operation and use of the device 1100. For example, storage component 1130 may include a hard disk (e.g., a magnetic disk, an optical disk, a magneto-optic disk, and/or a solid-state disk), a compact disc (CD), a digital versatile disc (DVD), a floppy disk, a cartridge, a magnetic tape, and/or another type of non-transitory computer-readable medium, along with a corresponding drive.

Input component 1140 is configured to receive information, such as user input. For example, the input component 1140 may include, but not be limited to, a touch screen display, a keyboard, a keypad, a mouse, a button, a switch, and/or a microphone. Additionally, or alternatively, the input component 1140 may include a sensor for sensing information (e.g., a global positioning system (GPS), an accelerometer, a gyroscope, and/or an actuator).

Output component 1150 is configured to provide output information from the device 1100. For example, the output component 1150 may be, but not limited to, a display, a speaker, instructions to an external device, and/or one or more light-emitting diodes (LEDs).

Communication interface 1160 is an interface that provides a communication connection to other devices, such as external devices and internal devices. The connection by the communication interface 1160 can be a wired connection, a wireless connection, or a combination of wired and wireless connections, and can be a direct connection or an indirect connection via a communication network that exists between the device 1100 and other devices. In other words, the standard of the communication interface 1160 is not limited.

The bus 1170 acts as an interconnect between the processor 1110, the memory 1120, the storage component 1130, the input component 1140, the output component 1150, and the communication interface 1160 of the device 1100. The bus 1170 may include a wired interconnection or a wireless interconnection.

The number and arrangement of components shown in FIG. 11 are provided as an example. In practice, device 1100 may include additional components, fewer components, different components, or differently arranged components than those shown in FIG. 11. Additionally, or alternatively, a set of components (e.g., one or more components) of device 1100 may perform one or more functions described as being performed by another set of components of device 1100. Further, one or more method steps described in any of the embodiments may be performed utilizing a plurality of devices 1100 in communication with one another.

### Example Implementation Environment

Example embodiments of the present disclosure may be implemented in any suitable type of environment. In the following, an example environment (in which the example embodiments may be implemented) is described.

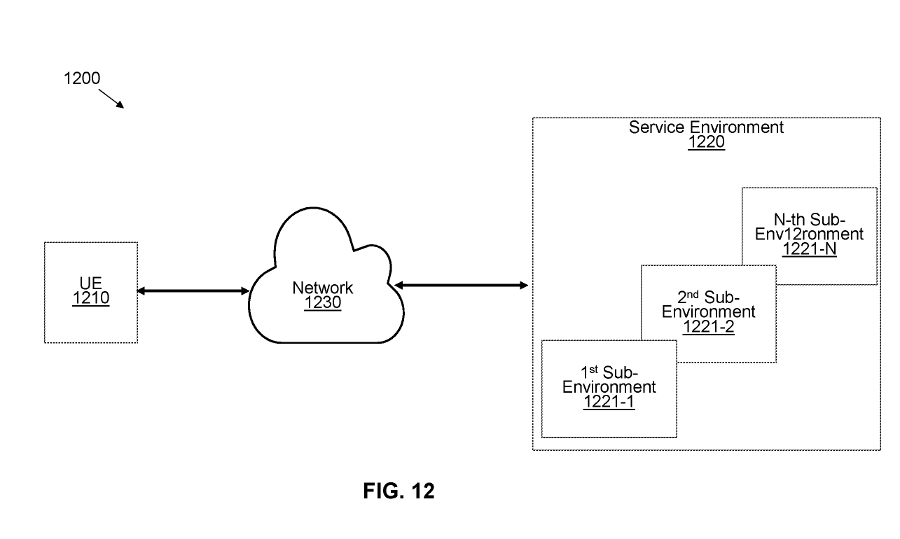

FIG. 12 illustrates a block diagram of an example environment 1200 in which systems and/or method, described herein, may be implemented. The implementation environment 1200 includes a UE (User equipment) 1210, a service environment 1220, and a network 1230. The service environment 1220 includes one or more sub-environments 1221. To illustrate this, FIG. 12 shows, for convenience, examples of a 1st sub-environment 1221-1, a 2nd sub-environment 1221-2, and an N-th sub-environment 1221-N (where N is any natural number).

The UE 1210 is connected to the network 1230, and the network 1230 is connected to the service environment 1220. The connections may be wired, wireless, or a combination of both wired and wireless. The UE 1210 and the service environment 1220 are connected via the network 1230.

The UE 1210 is a device that communicates with the service environment 1220. The UE 1210 receives information from the service environment 1220 and/or sends information to the service environment 1220. Also, the UE 1210 may generate and/or store information to be transmitted, as necessary. Also, the UE 1210 may store and/or process information that is received, as necessary.

The example FIG. 12 refers to the “UE”. However, it should be understood by those skilled in the art that general terms such as “user device,” “terminal,” “terminal device,” “communication device,” and “communication terminal” can be used interchangeably with the term “UE.”

For example, the UE 1210 may include a computing device (e.g., a desktop computer, a laptop computer, a tablet computer, a handheld computer, a smart speaker, a server, etc.), a mobile phone (e.g., a smart phone, a radiotelephone, etc.), a wearable device (e.g., a pair of smart glasses or a smart watch), or a similar device.

The service environment 1220 is an environment that communicates with the UE 1210 to provide one or more services. The service environment 1220 receives information from the UE 1210 and/or sends information to the UE 1210. Also, the service environment 1220 may generate and/or store information to be transmitted, as necessary. Also, the service environment 1220 may store and/or process information that is received, as necessary. For example, the service environment 1220 may provide computing resources as one of the services. It should be noted that the service is not limited to being provided to the UE; it may also be provided to devices other than the UE. For example, based on communication from the UE, the service may perform processes such as anomaly detection or traffic analysis and notify the results to a predetermined destination.

The example FIG. 12 refers to the “service environment”. The term "service environment" is used to refer to the broader context within which services operate. For example, cloud environments, platforms, computing systems, network systems, and cloud systems generally represent the environments in which services are conducted, and these are included within the "service environment." However, the "service environment" is not limited to these examples. Additionally, the specific types of environments within the "service environment" are not restricted. For instance, cloud environments and cloud systems can be categorized as private cloud, public cloud, hybrid cloud, or multi-cloud, all of which are included within the "service environment."

The one or more services provided by the service environment 1220 is not specifically limited and can be adjusted according to the embodiments. For example, the services may include a service that provides information to the UE 1210, a service that stores information from the UE 1210, or a service that performs processing based on information from the UE 1210 and returns the results of the processing.

In an embodiment, the Service Environments 1220 may also provide computing resources as the service. The computing resources can be hardware resources and/or software resources. For example, applications, processors, memory, and storage can be included in the provided computing resources. Each computing resource can communicate with other computing resources via wired connections, wireless connections, or a combination of wired and wireless connections.

The provided computing resources can be actual resources (also referred to as physical resources) and/or virtual resources. Furthermore, means of virtualization for virtual resources can be selected as appropriate. That is, in this disclosure, the use of adjectives such as "Virtual" or "Virtualized" to describe names does not imply that they are virtualized by a specific means of virtualization. For example, “virtual machine” refers to software that operates like an actual computer, realized through means of virtualization, and it is not intended to exclude those realized by specific means of virtualization such as Hypervisors or Containers. Conversely, when means of virtualization such as Hypervisors or containers are mentioned in this disclosure, it is merely cited as a general method of implementation. It should also be interpreted that embodiments implemented with other virtualization means are also disclosed. Also, the services may also be provided using resources virtualized by different means.

The service environment 1220 includes one or more devices, such as servers and network devices, which provide services or perform processes. The placement of these devices within the service environment 1220 can be determined as appropriate. Additionally, if the service environment 1220 includes one or more sub-environments 1221, the placement of devices can be determined based on predetermined policies for each sub-environment 1221. For example, devices related to the first service may be placed in the 1st sub-environment 1221-1, and devices related to the second service may be placed in the 2nd sub-environment 1221-2. In another example, devices expected to have a higher load than a predetermined threshold may be placed in the 1st sub-environment 1221-1, while devices expected to have a lower load than the predetermined threshold may be placed in the 2nd sub-environment 1221-2. In this way, specific devices can be placed in specific sub-environments 1221. Conversely, each sub-environment 1221 can be specialized for a particular purpose.

In an embodiment, all processes executed in a single service may run within a single service environment, or in multiple service environments. Multiple processes executed in a single service could be provided by different service environments.

The network 1230 is a network that exchanges information between the UE 1210 and the service environment 1220. The network 1230 includes one or more wired and/or wireless networks.

For example, the network 1230 may include a cellular network (e.g., a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, or the like, a non-terrestrial network (NTN), and/or a combination of these or other types of networks.

The network 1230 can be a part of a network. For example, in a 5G network that includes a RAN, a transport network, and a core network, the network 1230 can be at least one of the RAN, the transport network, or the core network. For example, the service environment 1220 could be in the core network, in which case the network 1230 could correspond to a network that is a combination of a RAN and a transport network and is part of the 5G network.

The number and arrangement of devices and networks shown in FIG. 12 are provided as an example. It should be understood that any changes that may be implemented by those skilled in the art, such as the addition or rearrangement of well-known devices or networks at the time of implementation, are included in this disclosure.

### Various Aspects of Embodiments

It is contemplated that features, advantages, and significances of example embodiments described hereinabove are merely examples of the present disclosure, and are not intended to be exhaustive or to limit the scope of the present disclosure.

Specifically, the foregoing disclosure provides illustration and description, but is not intended to be exhaustive or to limit the implementations to the precise form disclosed. Modifications and variations are possible in light of the above disclosure or may be acquired from practice of the implementations.

Some embodiments may relate to a device, a system, a method, and/or a computer-readable medium at any possible technical detail level of integration. Further, one or more of the above components described above may be implemented as instructions stored on a computer-readable medium and executable by at least one processor (and/or may include at least one processor). The computer-readable medium may include a computer-readable non-transitory storage medium (or media) having computer-readable program instructions thereon for causing a processor to carry out operations.

The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), electrically erasable programmable read-only memory (EEPROM), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer-readable program instructions from the network and forwards the computer-readable program instructions for storage in a computer-readable storage medium within the respective computing/processing device.

Computer-readable program code/instructions for carrying out operations may be assembler instructions, instruction-set-architecture (ISA) instructions, machine instructions, machine-dependent instructions, microcode, firmware instructions, state-setting data, configuration data for integrated circuitry, or either source code or object code written in any combination of one or more programming languages, including an object-oriented programming language such as Smalltalk, C++, or the like, and procedural programming languages, such as the "C" programming language or similar programming languages.

The computer-readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer-readable program instructions by utilizing state information of the computer-readable program instructions to personalize the electronic circuitry, in order to perform aspects or operations.

These computer-readable program instructions may be provided to a processor of a general-purpose computer, special-purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer-readable program instructions may also be loaded onto a computer, other programmable data processing apparatus, or other devices to cause a series of operational steps to be performed on the computer, other programmable apparatus or other devices to produce a computer-implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer-readable media according to various embodiments. In this regard, each block in the flowchart or block diagrams may represent a module, segment, or portion of instructions, which comprises one or more executable instructions for implementing the specified logical function(s). The method, computer system, and computer-readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limited to the implementations. Thus, the operation and behavior of the systems and/or methods were described herein without reference to specific software code—it is understood that software and hardware may be designed to implement the systems and/or methods based on the description herein.

In view of the above, various further respective aspects and features of embodiments of the present disclosure may be defined by the following items:

Item [1]: A system including: a device that comprises a Radio Link Control (RLC) layer and a Media Access Control (MAC) layer, wherein the device is configured to implement the RLC layer to: provide, to a Control Component, information associated with the RLC layer and information associated with the MAC layer; receive, from the Control Component, a suggested amount of grant bytes based on the information associated with the RLC layer and the information associated with the MAC layer; provide, to the MAC layer, a request for a first amount of grant bytes based on the suggested grant bytes; receive, from the MAC layer, a second amount of grant bytes based on the first amount of grant bytes; and schedule transmission of a data packet based on the second amount of grant bytes.

Item [2]: The system according to item [1], wherein the device is configured to implement the MAC layer to: receive, from the RLC layer, a request for the first amount of grant bytes; determine, based on the first amount of grant byte and a channel condition, the second amount of grant bytes; and provide, to the RLC layer, the second amount of grant bytes.

Item [3]: The system according to one or more of items [1]-[2], wherein the system further comprises the Control Component, and wherein the Control Component is configured to: receive, from the device, the information associated with the RLC layer and the information associated with the MAC layer; determine, based on the received information and information associated with the data packet, the suggested amount of grant bytes; and provide, to the device, the suggested amount of grant bytes.

Item [4]: The system according to item [3], wherein the Control Component is further configured to: determine, based on the received information, whether the channel condition is below a threshold; and based on determining that the channel condition is below the threshold, provide, to the device, a request to reduce a data packet receiving rate.

Item [5]: The system according to one or more of items [1]-[4], wherein the device is configured to implement the RLC layer to provide the request for the first amount of grant bytes by: determining whether there is an additional transmission pending in a buffer of the device; based on determining that there is no additional transmission pending in the buffer, providing, to the MAC layer, the suggested amount of grant bytes as the first amount of grant bytes; based on determining that there is an additional transmission pending in the buffer, combining the suggested amount of grant bytes with an amount of grant bytes required for the additional transmission to obtain the first amount of grant bytes; and providing, to the MAC layer, the first amount of grant bytes.

Item [6]: The system according to one or more of items [1]-[5], wherein the device is configured to implement the RLC layer to schedule the transmission of the data packet by: determining whether there is an additional transmission pending in a buffer of the device; based on determining that there is no additional transmission pending in the buffer, scheduling the transmission of the data packet based on the second amount of grant bytes; based on determining that there is an additional transmission pending in the buffer, scheduling the transmission of the data packet based on the second amount of grant bytes and a priority level of the transmission of the data packet.

Item [7]: The system according to one or more of items [1]-[6], wherein the device comprises a Distributed Unit (DU) of a telecommunication network, and wherein the Control Component comprises a Radio Access Network (RAN) Intelligent Controller (RIC).

Item [8]: The system according to one or more of items [1]-[7], wherein the device further comprises an E2 Control (E2C) Manager, and wherein the device is configured to implement the E2C Manager to: receive, from the Control Component, a first request to subscribe to the Control Component; provide, to the RLC layer, the first request to subscribe to the Control Component; receive, from the RLC layer, a second request to periodically accept the information of the RLC layer and the information of the MAC layer, wherein the second request comprises the information of the RLC layer and the information of the MAC layer; and provide the second request to the Control Component.

Item [9]: The system according to one or more of items [1]-[8], wherein the information associated with the RLC layer comprises information associated with at least one of: the data packet, a pending transmission, and a count of data the RLC layer can handle in one Transmission Time Interval (TTI); and wherein the information associated with the MAC layer comprises information associated with at least one of: the channel condition and a Quality of Service (QoS) requirement.

Item [10]: The system according to item [9], wherein the information associated with the data packet comprises information associated with at least one of: a queue depth that indicates a size of the data packet in bytes and a queue depth size that indicates the number of data packet in a slot; wherein the information associated with the pending transmission comprises at least one of: information associated with transmission of a MAC Control Element (CE), information associated with transmission of a Status Protocol Data Unit (PDU), information associated with retransmission of a data packet, information associated with transmission of a new segmented data packet, and information associated with the transmission of a new data packet; and wherein the information associated with the channel condition comprises at least one of: a Radio Network Temporary Identifier (RNTI), a Channel Quality Indicator (CQI), a Block Error Rate (BLER), a Modulation and Coding Scheme (MCS), a Bearer Identifier (ID), and a Physical Resource Blocks (PRBs) Status.

Item [11]: A method including: providing, to a Control Component, information associated with a Radio Link Control (RLC) layer of a device and information associated with a Media Access Control (MAC) layer of the device; receiving, from the Control Component, a suggested amount of grant bytes based on the information associated with the RLC layer and the information associated with the MAC layer; providing, to the MAC layer, a request for a first amount of grant bytes based on the suggested grant bytes; receiving, from the MAC layer, a second amount of grant bytes based on the first amount of grant bytes; and scheduling transmission of a data packet based on the second amount of grant bytes.

Item [12]: The method according to item [11], further comprising: receiving, from the RLC layer, a request for the first amount of grant bytes; determining, based on the first amount of grant byte and a channel condition, the second amount of grant bytes; and providing, to the RLC layer, the second amount of grant bytes.

Item [13]: The method according to one or more of items [11]-[12], further comprising: receiving, from the device, the information associated with the RLC layer and the information associated with the MAC layer; determining, based on the received information and information associated with the data packet, the suggested amount of grant bytes; and providing, to the device, the suggested amount of grant bytes.

Item [14]: The method according to item [13], further comprising: determining, based on the received information, whether the channel condition is below a threshold; and based on determining that the channel condition is below the threshold, providing, to the device, a request to reduce a data packet receiving rate.

Item [15]: The method according to one or more of items [11]-[14], wherein the providing the request for the first amount of grant bytes comprises: determining whether there is an additional transmission pending in a buffer of the device; based on determining that there is no additional transmission pending in the buffer, providing, to the MAC layer, the suggested amount of grant bytes as the first amount of grant bytes; based on determining that there is an additional transmission pending in the buffer, combining the suggested amount of grant bytes with an amount of grant bytes required for the additional transmission to obtain the first amount of grant bytes; and providing, to the MAC layer, the first amount of grant bytes.

Item [16]: The method according to one or more of items [11]-[15], wherein the scheduling the transmission of the data packet comprises: determining whether there is an additional transmission pending in a buffer of the device; based on determining that there is no additional transmission pending in the buffer, scheduling the transmission of the data packet based on the second amount of grant bytes; based on determining that there is an additional transmission pending in the buffer, scheduling the transmission of the data packet based on the second amount of grant bytes and a priority level of the transmission of the data packet.

Item [17]: The method according to one or more of items [11]-[16], wherein the device comprises a Distributed Unit (DU) of a telecommunication network, and wherein the Control Component comprises a Radio Access Network (RAN) Intelligent Controller (RIC).

Item [18]: The method according to one or more of items [11]-[17], further comprising: receiving, from the Control Component, a first request to subscribe to the Control Component; providing, to the RLC layer, the first request to subscribe to the Control Component; receiving, from the RLC layer, a second request to periodically accept the information of the RLC layer and the information of the MAC layer, wherein the second request comprises the information of the RLC layer and the information of the MAC layer; and providing the second request to the Control Component.

Item [19]: The method according to one or more of items [11]-[18], wherein the information associated with the RLC layer comprises information associated with at least one of: the data packet, a pending transmission, and a count of data the RLC layer can handle in one Transmission Time Interval (TTI); and wherein the information associated with the MAC layer comprises information associated with at least one of: the channel condition and a Quality of Service (QoS) requirement.

Item [20]: A non-transitory computer-readable recording medium having recorded thereon instructions executable by a device to cause the device to perform a method comprising: providing, to a Control Component, information associated with a Radio Link Control (RLC) layer of the device and information associated with a Media Access Control (MAC) layer of the device; receiving, from the Control Component, a suggested amount of grant bytes based on the information associated with the RLC layer and the information associated with the MAC layer; providing, to the MAC layer, a request for a first amount of grant bytes based on the suggested grant bytes; receiving, from the MAC layer, a second amount of grant bytes based on the first amount of grant bytes; and scheduling transmission of a data packet based on the second amount of grant bytes.

It can be understood that numerous modifications and variations of the present disclosure are possible in light of the above teachings. It will be apparent that within the scope of the appended clauses, the present disclosures may be practiced otherwise than as specifically described herein.

What is claimed is:

1. A system comprising:
a device that comprises a Radio Link Control (RLC) layer and a Media Access Control (MAC) layer,
wherein the device is configured to implement the RLC layer to:
provide, to a Control Component, information associated with the RLC layer and information associated with the MAC layer;
receive, from the Control Component, a suggested amount of grant bytes based on the information associated with the RLC layer and the information associated with the MAC layer;
provide, to the MAC layer, a request for a first amount of grant bytes based on the suggested grant bytes;
receive, from the MAC layer, a second amount of grant bytes based on the first amount of grant bytes; and
schedule transmission of a data packet based on the second amount of grant bytes.

2. The system according to claim 1, wherein the device is configured to implement the MAC layer to:
receive, from the RLC layer, a request for the first amount of grant bytes;
determine, based on the first amount of grant byte and a channel condition, the second amount of grant bytes; and
provide, to the RLC layer, the second amount of grant bytes.

3. The system according to claim 1, wherein the system further comprises the Control Component, and wherein the Control Component is configured to:
receive, from the device, the information associated with the RLC layer and the information associated with the MAC layer;
determine, based on the received information and information associated with the data packet, the suggested amount of grant bytes; and
provide, to the device, the suggested amount of grant bytes.

4. The system according to claim 3, wherein the Control Component is further configured to:
determine, based on the received information, whether the channel condition is below a threshold; and
based on determining that the channel condition is below the threshold, provide, to the device, a request to reduce a data packet receiving rate.

5. The system according to claim 1, wherein the device is configured to implement the RLC layer to provide the request for the first amount of grant bytes by:
determining whether there is an additional transmission pending in a buffer of the device;
based on determining that there is no additional transmission pending in the buffer, providing, to the MAC layer, the suggested amount of grant bytes as the first amount of grant bytes;
based on determining that there is an additional transmission pending in the buffer, combining the suggested amount of grant bytes with an amount of grant bytes required for the additional transmission to obtain the first amount of grant bytes; and
providing, to the MAC layer, the first amount of grant bytes.

6. The system according to claim 1, wherein the device is configured to implement the RLC layer to schedule the transmission of the data packet by:
determining whether there is an additional transmission pending in a buffer of the device;
based on determining that there is no additional transmission pending in the buffer, scheduling the transmission of the data packet based on the second amount of grant bytes; and based on determining that there is an additional transmission pending in the buffer, scheduling the transmission of the data packet based on the second amount of grant bytes and a priority level of the transmission of the data packet.

7. The system according to claim 1, wherein the device comprises a Distributed Unit (DU) of a telecommunication network, and wherein the Control Component comprises a Radio Access Network (RAN) Intelligent Controller (RIC).

8. The system according of claim 1, wherein the device further comprises an E2 Control (E2C) Manager, and wherein the device is configured to implement the E2C Manager to:
receive, from the Control Component, a first request to subscribe to the Control Component;
provide, to the RLC layer, the first request to subscribe to the Control Component;
receive, from the RLC layer, a second request to periodically accept the information of the RLC layer and the information of the MAC layer, wherein the second request comprises the information of the RLC layer and the information of the MAC layer; and
provide the second request to the Control Component.

9. The system according to claim 1,
wherein the information associated with the RLC layer comprises information associated with at least one of: the data packet, a pending transmission, and a count of data the RLC layer can handle in one Transmission Time Interval (TTI); and
wherein the information associated with the MAC layer comprises information associated with at least one of: the channel condition and a Quality of Service (QoS) requirement.

10. The system according to claim 9,
wherein the information associated with the data packet comprises information associated with at least one of: a queue depth that indicates a size of the data packet in bytes and a queue depth size that indicates the number of data packet in a slot;
wherein the information associated with the pending transmission comprises at least one of: information associated with transmission of a MAC Control Element (CE), information associated with transmission of a Status Protocol Data Unit (PDU), information associated with retransmission of a data packet, information associated with transmission of a new segmented data packet, and information associated with the transmission of a new data packet; and
wherein the information associated with the channel condition comprises at least one of: a Radio Network Temporary Identifier (RNTI), a Channel Quality Indicator (CQI), a Block Error Rate (BLER), a Modulation and Coding Scheme (MCS), a Bearer Identifier (ID), and a Physical Resource Blocks (PRBs) Status.

11. A method comprising:
providing, to a Control Component, information associated with a Radio Link Control (RLC) layer of a device and information associated with a Media Access Control (MAC) layer of the device;
receiving, from the Control Component, a suggested amount of grant bytes based on the information associated with the RLC layer and the information associated with the MAC layer;
providing, to the MAC layer, a request for a first amount of grant bytes based on the suggested grant bytes;
receiving, from the MAC layer, a second amount of grant bytes based on the first amount of grant bytes; and
scheduling transmission of a data packet based on the second amount of grant bytes.

12. The method according to claim 11, further comprising:
receiving, from the RLC layer, a request for the first amount of grant bytes;
determining, based on the first amount of grant byte and a channel condition, the second amount of grant bytes; and
providing, to the RLC layer, the second amount of grant bytes.

13. The method according to claim 11, further comprising:
receiving, from the device, the information associated with the RLC layer and the information associated with the MAC layer;
determining, based on the received information and information associated with the data packet, the suggested amount of grant bytes; and
providing, to the device, the suggested amount of grant bytes.

14. The method according to claim 13, further comprising:
determining, based on the received information, whether the channel condition is below a threshold; and
based on determining that the channel condition is below the threshold, providing, to the device, a request to reduce a data packet receiving rate.

15. The method according to claim 11, wherein the providing the request for the first amount of grant bytes comprises:
determining whether there is an additional transmission pending in a buffer of the device;
based on determining that there is no additional transmission pending in the buffer, providing, to the MAC layer, the suggested amount of grant bytes as the first amount of grant bytes;
based on determining that there is an additional transmission pending in the buffer, combining the suggested amount of grant bytes with an amount of grant bytes required for the additional transmission to obtain the first amount of grant bytes; and
providing, to the MAC layer, the first amount of grant bytes.

16. The method according to claim 11, wherein the scheduling the transmission of the data packet comprises:
determining whether there is an additional transmission pending in a buffer of the device;
based on determining that there is no additional transmission pending in the buffer, scheduling the transmission of the data packet based on the second amount of grant bytes; and based on determining that there is an additional transmission pending in the buffer, scheduling the transmission of the data packet based on the second amount of grant bytes and a priority level of the transmission of the data packet.

17. The method according to claim 11, wherein the device comprises a Distributed Unit (DU) of a telecommunication network, and wherein the Control Component comprises a Radio Access Network (RAN) Intelligent Controller (RIC).

18. The method according to claim 11, further comprising:
receiving, from the Control Component, a first request to subscribe to the Control Component;
providing, to the RLC layer, the first request to subscribe to the Control Component;
receiving, from the RLC layer, a second request to periodically accept the information of the RLC layer and the information of the MAC layer, wherein the second request comprises the information of the RLC layer and the information of the MAC layer; and
providing the second request to the Control Component.

19. The method according to claim 11, wherein:
the information associated with the RLC layer comprises information associated with at least one of: the data packet, a pending transmission, and a count of data the RLC layer can handle in one Transmission Time Interval (TTI); and
the information associated with the MAC layer comprises information associated with at least one of: the channel condition and a Quality of Service (QoS) requirement.

20. A non-transitory computer-readable recording medium having recorded thereon instructions executable by a device to cause the device to perform a method comprising:
providing, to a Control Component, information associated with a Radio Link Control (RLC) layer of the device and information associated with a Media Access Control (MAC) layer of the device;
receiving, from the Control Component, a suggested amount of grant bytes based on the information associated with the RLC layer and the information associated with the MAC layer;
providing, to the MAC layer, a request for a first amount of grant bytes based on the suggested grant bytes;
receiving, from the MAC layer, a second amount of grant bytes based on the first amount of grant bytes; and
scheduling transmission of a data packet based on the second amount of grant bytes.
